(19) United States
(12) Patent Application Publication
(10) Pub. No.: US 2025/0047772 A1
(43) Pub. Date: Feb. 6, 2025

(54) ELECTRONIC DEVICE FOR SHARING SCREEN WITH EXTERNAL ELECTRONIC DEVICE, OPERATING METHOD THEREFOR AND STORAGE MEDIUM

(71) Applicant: Samsung Electronics Co., Ltd., Suwon-si (KR)

(72) Inventors: Ohyoon KWON, Suwon-si (KR); Hyojin BAE, Suwon-si (KR); Jaehyun HAN, Suwon-si (KR); Younghak OH, Suwon-si (KR); Kyuho SHIN, Suwon-si (KR); Sueyeon LEE, Suwon-si (KR)

(21) Appl. No.: 18/920,269

(22) Filed: Oct. 18, 2024

Related U.S. Application Data
(63) Continuation of application No. PCT/KR2023/003095, filed on Mar. 7, 2023.

(30) Foreign Application Priority Data
Apr. 19, 2022 (KR) 10-2022-0048543
Jul. 27, 2022 (KR) 10-2022-0093499

(51) Int. Cl. H04M 1/72412; H04M 1/02

(52) U.S. Cl. CPC H04M 1/72412; H04M 1/0268; H04M 2201/38; H04M 2201/42

(57) ABSTRACT

An electronic device is provided. The electronic device includes a display, a communication module and at least one processor, wherein the at least one processor connects with an external electronic device including a flexible display that can extend in one or more directions, displays an object corresponding to at least one application execution screen on the display, identifies a user input for displaying the object on the display of the external electronic device, displays, on the basis of the user input, on at least a part of the display, an indicator for changing the size of the flexible display, and can control, on the basis of an input for selecting the indicator, that the object is displayed on the flexible display of which the size has been changed.

### CROSS-REFERENCE TO RELATED APPLICATION(S)

This application is a continuation application, claiming priority under 35 U.S.C. § 365 (c), of an International application No. PCT/KR2023/003095, filed on Mar. 7, 2023, which is based on and claims the benefit of a Korean patent application number 10-2022-0048543, filed on Apr. 19, 2022, in the Korean Intellectual Property Office, and of a Korean patent application number 10-2022-0093499, filed on Jul. 27, 2022, in the Korean Intellectual Property Office, the disclosure of each of which is incorporated by reference herein in its entirety.

### BACKGROUND

### 1. Field

The disclosure relates to an electronic device for sharing a screen with an external electronic device, a method for operating the same, and a storage medium.

### 2. Description of Related Art

An increase in the processing speed of the mobile communication and processor of electronic devices such as smartphones leads to advent of smartphones equipped with various open operating systems and brand-new services. The enhanced performance of smartphones, as high as compatible with that of personal computers, puts smartphones to more frequent use as compared with other devices such as desktop PCs laptop computers, etc. Accordingly, smart phones users are storing and using various files on their smartphones rather than on their desktops.

Further, as demand for viewing of various contents on an electronic device increases, a diversity of techniques for sharing such content are being developed. For example, the user may share the screen displayed on an electronic device by displaying the screen through at least one external electronic device connected to the electronic device. As such, various technologies for connecting an electronic device to an external electronic device and using the electronic device as needed by the user are being developed.

The above information is presented as background information only to assist with an understanding of the disclosure. No determination has been made, and no assertion is made, as to whether any of the above might be applicable as prior art with regard to the disclosure.

### SUMMARY

Since the content output on the display of an electronic device is real-time output on the display of an external electronic device, the user may view the content on the electronic device through the external electronic device.

However, a device, such as an external electronic device having a resizable display exposure area (e.g., an electronic device including a flexible display), is capable of resizing the display exposure area and thus requires that usability of the external electronic device be increased.

Aspects of the disclosure are to address at least the above-mentioned problems and/or disadvantages and to provide at least the advantages described below. Accordingly, an aspect of the disclosure is to provide an electronic device for sharing a screen with an external electronic device, an operation method thereof, and a storage medium, in which an electronic device may increase the usability of an external electronic device having a resizable display exposure area.

Additional aspects will be set forth in part in the description which follows and, in part, will be apparent from the description, or may be learned by practice of the presented embodiments.

In accordance with an aspect of the disclosure, an electronic device is provided. The electronic device includes a display, a communication module, memory storing one or more computer programs, and one or more processors communicatively coupled to the communication module, the display, and the memory, wherein the one or more computer programs include computer-executable instructions that, when executed by the one or more processors individually or collectively, cause the electronic device to perform a connection with an external electronic device including a flexible display extendable in one or more directions, display an object corresponding to at least one application execution screen on the display, identify a user input for displaying the object on the flexible display of the external electronic device, display an indicator for resizing the flexible display on at least a portion of the display based on the user input, and control to display the object on the resized flexible display based on an input selecting the indicator.

In accordance with another aspect of the disclosure, a method performed by an electronic device to share a screen with an external electronic device is provided. The method includes performing a connection with the external electronic device including a flexible display extendable in one or more directions, displaying an object corresponding to at least one application execution screen on a display of the electronic device, identifying a user input for displaying the object on the flexible display of the external electronic device, displaying an indicator for resizing the flexible display on at least a portion of the display based on the user input, and controlling to display a screen corresponding to the object on the resized flexible display based on an input selecting the indicator.

In accordance with another aspect of the disclosure, one or more non-transitory computer-readable storage media storing one or more computer programs including computer-executable instructions that, when executed by one or more processors of an electronic device individually or collectively, cause the electronic device to perform at least one operation is provided. The at least one operation includes performing a connection with an external electronic device including a flexible display extendable in one or more directions, displaying an object corresponding to at least one application execution screen on a display of the electronic device, identifying a user input for displaying the object on the flexible display of the external electronic device, displaying an indicator for resizing the flexible display on at least a portion of the display based on the user input, and controlling to display a screen corresponding to the object on the resized flexible display based on an input selecting the indicator.

According to various embodiments, when an electronic device moves and displays screen data displayed on the display of the electronic device to an external electronic device, it may resize the exposure area of the display of the external electronic device and display the same, thereby increasing user convenience.

According to an embodiment of the disclosure, as it is displayed on the electronic device whether the display of the external electronic device is resizable when screen data (e.g., content or application widow) of the electronic device is moved to the external electronic device, the user may intuitively recognize that the display of the external electronic device is resizable.

According to various embodiments, it is possible to provide an optimized screen corresponding to the screen data of the electronic device to the user who desires to resize the display of the external electronic device and to contribute to enhancing usability, convenience, and competitiveness of the external electronic device when the electronic device interworks with the external electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a block diagram illustrating an electronic device in a network environment according to an embodiment of the disclosure;

FIG. 1B is a view illustrating a state in which a second display area of a display is received in a housing according to an embodiment of the disclosure;

FIG. 1C is a view illustrating a state in which a second display area of a display is exposed to the outside of a housing according to an embodiment of the disclosure;

FIG. 1D is an exploded perspective view illustrating an electronic device according to an embodiment of the disclosure;

FIG. 1E is a cross-sectional view taken along line A-A′ of FIG. 1B according to an embodiment of the disclosure;

FIG. 1F is a cross-sectional view taken along line B-B′ of FIG. 1B according to an embodiment of the disclosure;

FIG. 2 is a view illustrating a connection relationship between an electronic device and an external electronic device according to an embodiment of the disclosure;

FIG. 3 is an example view illustrating a shrunken and extended state of a flexible display in a vertical (e.g., portrait mode) direction in an external electronic device according to an embodiment of the disclosure;

FIG. 4 is an example view illustrating a shrunken and extended state of a flexible display in a horizontal (e.g., landscape mode) direction in an external electronic device according to an embodiment of the disclosure;

FIG. 5 is a block diagram illustrating an internal configuration of an electronic device for controlling an external electronic device according to an embodiment of the disclosure;

FIG. 6 is a flowchart illustrating operations of an electronic device to control an external electronic device according to an embodiment of the disclosure;

FIG. 7 is a view illustrating an example of sharing an object related to at least one application output on a display of an electronic device with an external electronic device according to an embodiment of the disclosure;

FIG. 8 is an example view illustrating a method for selecting a display mode when a flexible display of an external electronic device is extended according to an embodiment of the disclosure;

FIG. 9A is an example view illustrating a method for setting a position where an external electronic device is placed with respect to an electronic device according to an embodiment of the disclosure;

FIG. 9B is an example view illustrating a method for setting a position where an external electronic device is placed with respect to an electronic device according to an embodiment of the disclosure;

FIG. 9C is an example view illustrating a method for setting a position where an external electronic device is placed with respect to an electronic device according to an embodiment of the disclosure;

FIG. 9D is an example view illustrating a method for setting a position where an external electronic device is placed with respect to an electronic device according to an embodiment of the disclosure;

FIG. 10 is an example view illustrating a screen on an extended flexible display corresponding to selection of a split view mode when an object moves in an electronic device according to an embodiment of the disclosure;

FIG. 11 is an example view illustrating a screen on an extended flexible display corresponding to selection of a popup view mode when an object moves in an electronic device according to an embodiment of the disclosure;

FIG. 12 is an example view illustrating a screen on a flexible display before extension is completed, corresponding to selection of a popup view mode when an object moves in an electronic device according to an embodiment of the disclosure;

FIG. 13 is an example view illustrating a screen on a shrunken flexible display corresponding to selection of a shrink function when an object moves in an electronic device according to an embodiment of the disclosure;

FIG. 14 is an example view illustrating a screen where a screen corresponding to an object is displayed without resizing of a flexible display when an object moves according to an embodiment of the disclosure;

FIG. 15 is an example view illustrating a screen in which a flexible display is automatically enlarged to correspond to the size of an object according to an embodiment of the disclosure;

FIG. 16 is an example view illustrating a screen in which a flexible display is automatically shrunken to correspond to the size of an object according to an embodiment of the disclosure;

FIG. 17A is an example view illustrating a screen based on attributes of an object and an external electronic device in a vertical state according to an embodiment of the disclosure;

FIG. 17B is an example view illustrating a screen based on attributes of an object and an external electronic device in a vertical state according to an embodiment of the disclosure;

FIG. 18A is an example view illustrating a screen based on attributes of an object and an external electronic device in a horizontal state according to an embodiment of the disclosure; and

FIG. 18B is an example view illustrating a screen based on attributes of an object and an external electronic device in a horizontal state according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

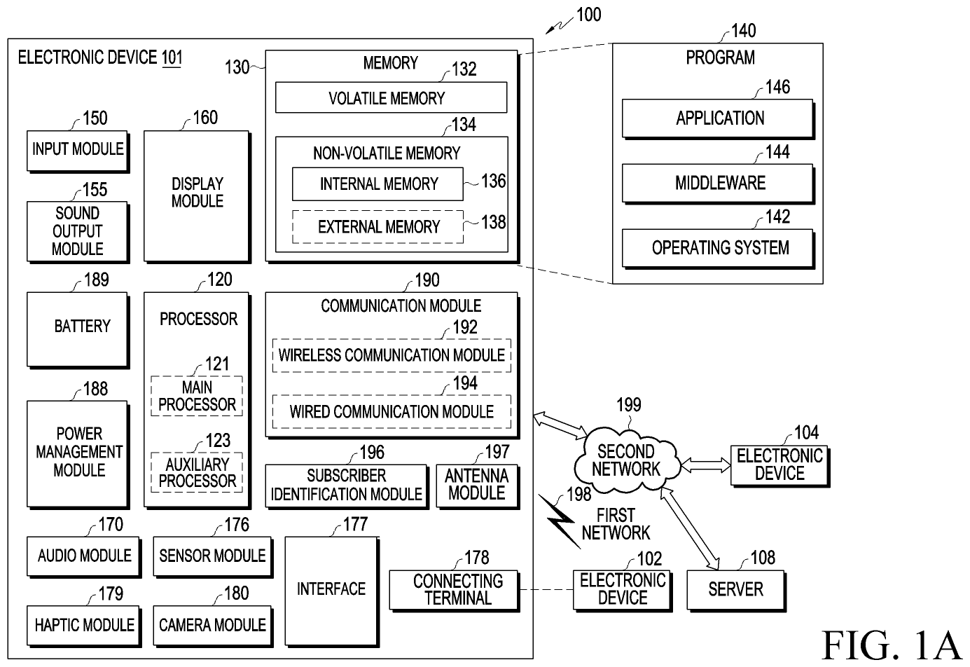

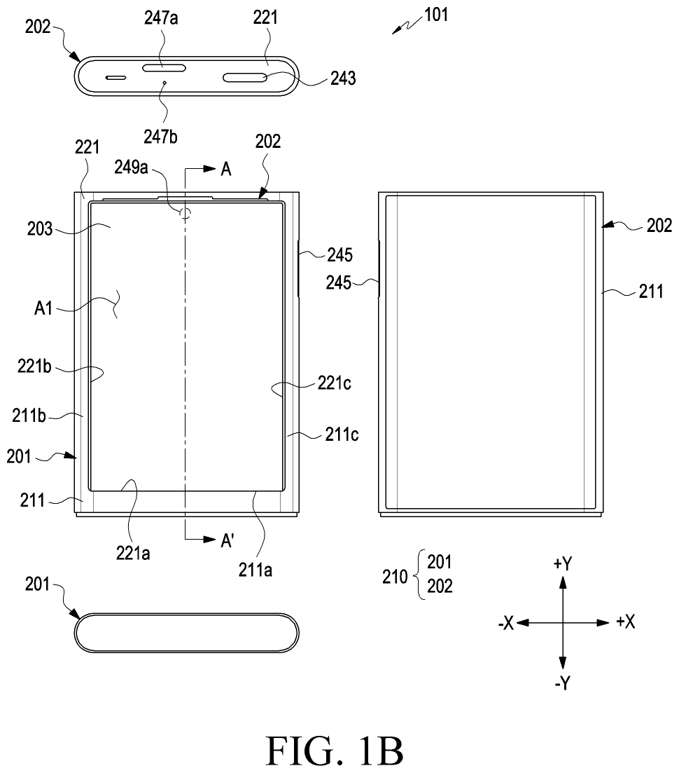

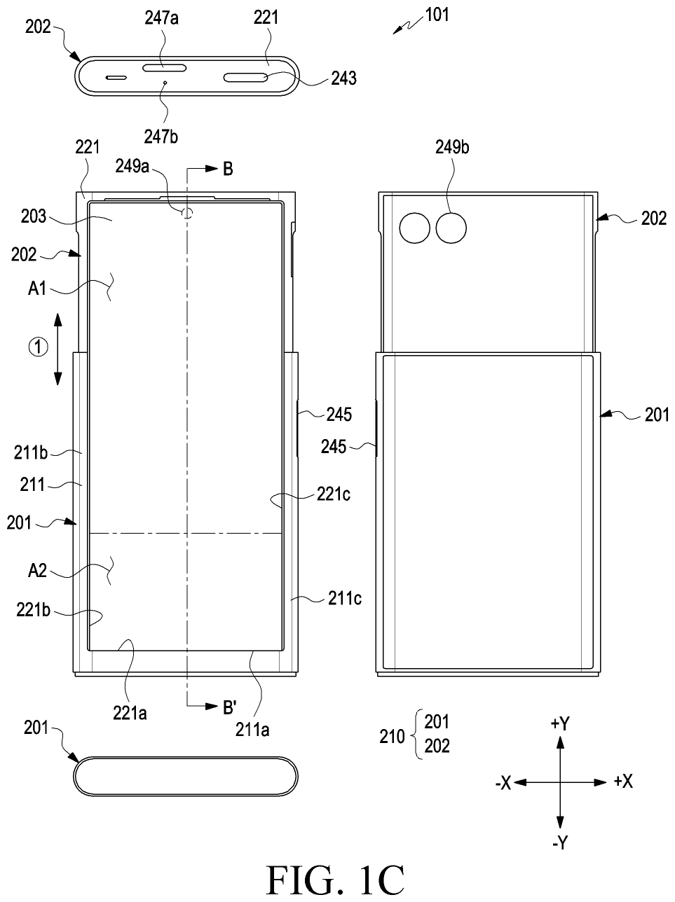

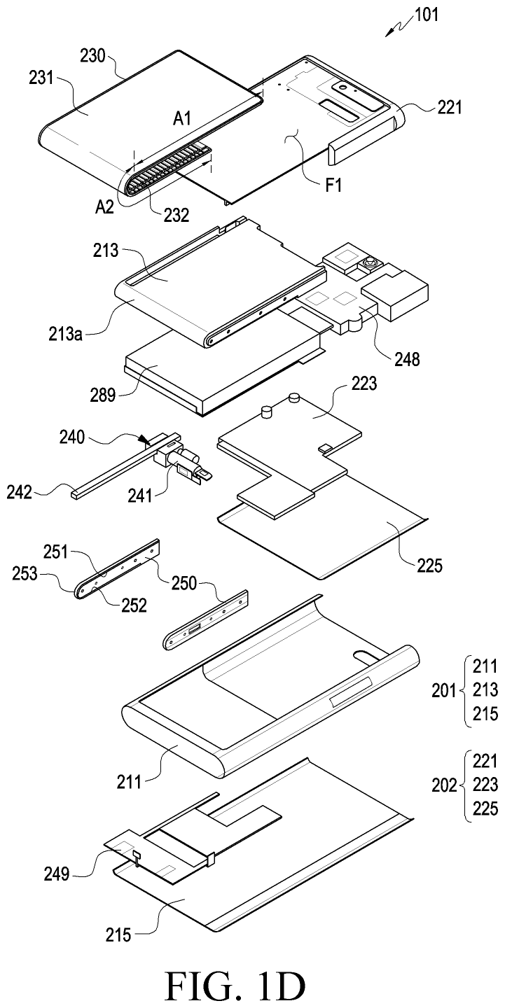

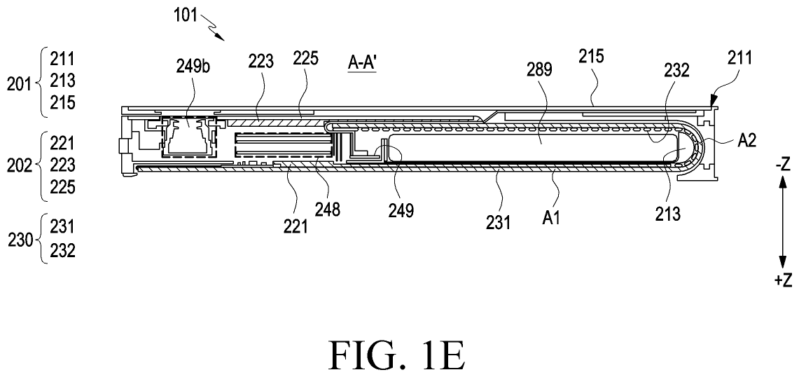

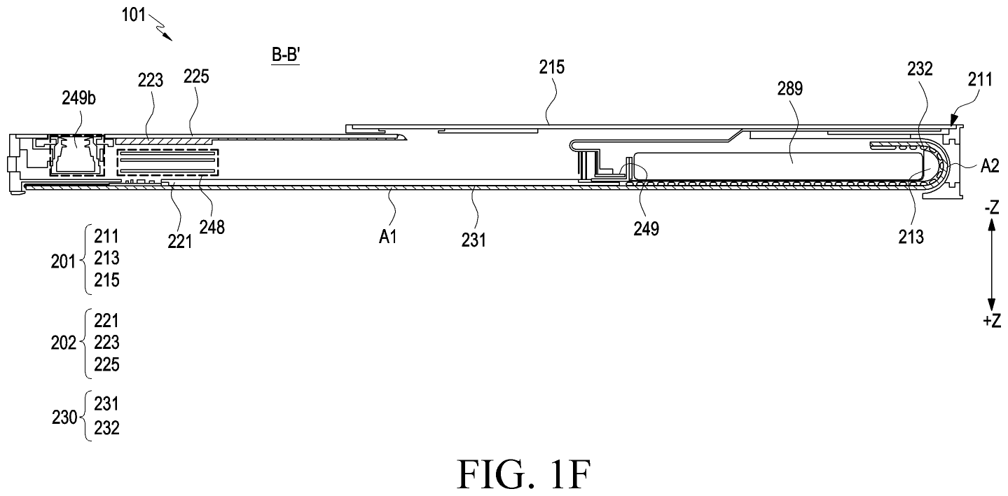

FIG. 1A is a block diagram illustrating an electronic device 101 in a network environment 100 according to an embodiment of the disclosure.

Referring to FIG. 1A, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

FIG. 1B is a view illustrating a state in which a second display area of a display is received in a housing according to an embodiment of the disclosure. FIG. 1C is a view illustrating a state in which a second display area of a display is exposed to the outside of a housing according to an embodiment of the disclosure.

FIGS. 1B and 1C illustrate a structure in which the display 203 (e.g., flexible display or rollable display) is extended in the length direction (e.g., +Y direction) when the electronic device 101 is viewed from the front. However, the extending direction of the display 203 is not limited to one direction (e.g., +Y direction). For example, the extending direction of the display 203 may be changed in design to be extendable in the upper direction (+Y direction), right direction (e.g., +X direction), left direction (e.g., −X direction), and/or lower direction (e.g., −Y direction).

The state shown in FIG. 1B may be referred to as a closed state of the electronic device 101 or housing 210 and a slide-in state of the display 203.

The state shown in FIG. 1C may be referred to as an opened state of the electronic device 101 or housing 210 and a slide-out state of the display 203.

Referring to FIGS. 1B and 1C, the electronic device 101 may include a housing 210. The housing 210 may include a first housing 201 and a second housing 202 disposed to be movable relative to the first housing 201. According to an embodiment, the electronic device 101 may be interpreted as having a structure in which the first housing 201 is disposed to be slidable with respect to the second housing 202. According to an embodiment, the second housing 202 may be disposed to perform reciprocating motion by a predetermined distance in a predetermined direction with respect to the first housing 201, for example, a direction indicated by an arrow \textcircled{1}.

According to an embodiment, the second housing 202 may be referred to as a slide portion or a slide housing, and may be movable relative to the first housing 201. According to an embodiment, the second housing 202 may receive various electrical/electronic components, such as a circuit board or a battery.

According to an embodiment, the first housing 201 may have, disposed therein, a motor, a speaker, a sim socket, and/or a sub circuit board electrically connected with a main circuit board. The first housing 201 may receive a main circuit board on which electric components, such as an application processor (AP) and a communication processor (CP) are mounted.

According to an embodiment, the first housing 201 may include a first cover member 211 (e.g., a main case). The first cover member 211 may include a 1-1th sidewall 211a, a 1-2th sidewall 211b extending from the 1-1th sidewall 211a, and a 1-3th sidewall 211c extending from the 1-1th sidewall 211a and substantially parallel to the 1-2th sidewall 211b. According to an embodiment, the 1-2th sidewall 211b and the 1-3th sidewall 211c may be formed substantially perpendicular to the 1-1th sidewall 211a.

According to an embodiment, the 1-1th sidewall 211a, 1-2th sidewall 211b, and 1-3th sidewall 211c of the first cover member 211 may be formed to have a side opening (e.g., front opening) to receive (or surround) at least a portion of the second housing 202. For example, at least a portion of the second housing 202 may be surrounded by the first housing 201 and be slid in the direction parallel to the first surface (e.g., the first surface F1 of FIG. 1D), e.g., arrow \textcircled{1} direction, while being guided by the first housing 201. According to an embodiment, the 1-1th sidewall 211a, the 1-2th sidewall 211b, and/or the 1-3th sidewall 211c of the first cover member 211 may be integrally formed. According to an embodiment, the 1-1th sidewall 211a, the 1-2th sidewall 211b, and/or the 1-3th sidewall 211c of the first cover member 211 may be formed as separate structures and be combined or assembled.

According to an embodiment, the first cover member 211 may be formed to surround at least a portion of the display 203. For example, at least a portion of the display 203 may be formed to be surrounded by the 1-1th sidewall 211a, the 1-2th sidewall 211b, and/or the 1-3th sidewall 211c of the first cover member 211.

According to an embodiment, the second housing 202 may include a second cover member 221 (e.g., a slide plate). The second cover member 221 may have a plate shape and include a first surface (e.g., the first surface F1 of FIG. 1D) supporting internal components. For example, the second cover member 221 may support at least a portion of the display 203 (e.g., the first display area A1). According to an embodiment, the second cover member 221 may be referred to as a front cover.

According to an embodiment, the second cover member 221 may include a 2-1th sidewall 221a, a 2-2th sidewall 221b extending from the 2-1th sidewall 221a, and a 2-3th sidewall 221c extending from the 2-1th sidewall 221a and substantially parallel to the 2-2th sidewall 221b. According to an embodiment, the 2-2th sidewall 221b and the 2-3th sidewall 221c may be formed substantially perpendicular to the 2-1th sidewall 221a.

According to an embodiment, as the second housing 202 moves in a first direction (e.g., direction \textcircled{1}) parallel to the 1-2th sidewall 211b or the 1-3th sidewall 211c, the housing 210 may form an opened state and a closed state. In the closed state, the second housing 202 may be positioned at a first distance from the 1-1th sidewall 211a and, in the opened state, the second housing 202 may be moved to be positioned at a second distance larger than the first distance from the 1-1th sidewall 211a. In some embodiments, in the closed state, the first housing 201 may surround a portion of the 2-1th side wall 221a.

According to an embodiment, the electronic device 101 may include a display 203, a key input device 245, a connector hole 243, audio modules 247a and 247b, or camera modules 249a and 249b. According to an embodiment, the electronic device 101 may further include an indicator (e.g., a light emitting diode (LED) device) or various sensor modules.

According to an embodiment, the display 203 may include a first display area A1 and a second display area A2 configured to be exposed to the outside of the electronic device 101 based on the slide of the second housing 202. According to an embodiment, the first display area A1 may be disposed on the second housing 202. For example, the first display area A1 may be disposed on the second cover member 221 of the second housing 202. According to an embodiment, the second display area A2 may extend from the first display area A1, and as the second housing 202 slides relative to the first housing 201, the second display area A2 may be received in the first housing 201 (e.g., the slide-in state) or be visually exposed to the outside of the electronic device 101 (e.g., the slide-out state).

According to an embodiment, the second display area A2 may be received in the space positioned inside the first housing 201 or exposed to the outside of the electronic device while being substantially guided by one area (e.g., the curved surface 213a of FIG. 1D) of the first housing 201. According to an embodiment, the second display area A2 may move based on a slide of the second housing 202 in the first direction (e.g., the direction indicated by the arrow \textcircled{1}). For example, while the second housing 202 slides, a portion of the second display area A2 may be deformed into a curved shape in a position corresponding to the curved surface 213a of the first housing 201.

According to an embodiment, when viewed from above the second cover member 221 (e.g., front cover), if the electronic device 101 changes from the closed state to opened state (e.g., if the second housing 202 slides to extend from the first housing 201), the second display area A2 may be gradually exposed to the outside of the first housing 201 and, together with the first display area A1, form a substantially flat surface. According to an embodiment, the display 203 may be coupled with or disposed adjacent to a touch detection circuit, a pressure sensor capable of measuring the strength (pressure) of touches, and/or a digitizer for detecting a magnetic field-type stylus pen. According to an embodiment, irrespective of the closed state or opened state of the housing 210, the exposed portion of the second display area A2 may be positioned on a portion (e.g., the curved surface 213a of FIG. 1D) of the first housing, and a portion of the second display area A2 may remain in the curved shape in the position corresponding to the curved surface 213a.

According to an embodiment, the key input device 245 may be positioned in one area of the first housing 201. Depending on the appearance and the state of use, the electronic device 101 may be designed to omit the illustrated key input device 245 or to include additional key input device(s). According to an embodiment, the electronic device 101 may include a key input device (not shown), e.g., a home key button or a touchpad disposed around the home key button. According to an embodiment, at least a portion of the key input device 245 may be disposed on the 1-1th sidewall 211a, the 1-2th sidewall 211b, or the 1-3th sidewall 211c of the first housing 201.

According to an embodiment, the connector hole 243 may be omitted or may receive a connector (e.g., a universal serial bus (USB) connector) for transmitting and receiving power and/or data with an external electronic device. According to an embodiment (not shown), the electronic device 101 may include a plurality of connector holes 243, and some of the plurality of connector holes 243 may function as connector holes for transmitting/receiving audio signals with an external electronic device. In the illustrated embodiment, the connector hole 243 is disposed in the second housing 202, but is not limited thereto. For example, the connector hole 243 or a connector hole not shown may be disposed in the first housing 201.

According to an embodiment, the audio modules 247a and 247b may include at least one speaker hole 247a or at least one microphone hole 247b. One of the speaker holes 247a may be provided as a receiver hole for voice calls, and the other may be provided as an external speaker hole. The electronic device 101 may include a microphone for obtaining sound. The microphone may obtain external sound of the electronic device 101 through the microphone hole 247b. According to an embodiment, the electronic device 101 may include a plurality of microphones to detect the direction of sound. According to an embodiment, the electronic device 101 may include an audio module in which the speaker hole 247a and the microphone hole 247b are implemented as one hole or may include a speaker without the speaker hole 247a (e.g., a piezo speaker).

According to an embodiment, the camera modules 249a and 249b may include a first camera module 249a (e.g., a front camera) and a second camera module 249b (e.g., a rear camera) (e.g., the second camera module 249b of FIGS. 1E and 1F). According to an embodiment, the electronic device 101 may include at least one of a wide-angle camera, a telephoto camera, or a close-up camera. According to an embodiment, the electronic device 101 may measure the distance to the subject by including an infrared projector and/or an infrared receiver. The camera modules 249a and 249b may include one or more lenses, an image sensor, and/or an image signal processor. The first camera module 249a may be disposed to face in the same direction as the display 203. For example, the first camera module 249a may be disposed in an area around the first display area A1 or overlapping the display 203. When disposed in the area overlapping the display 203, the first camera module 249a may capture the subject through the display 203. According to an embodiment, the first camera module 249a may include an under display camera (UDC) that has a screen display area (e.g., the first display area A1) that may not be visually exposed but hidden. According to an embodiment, the second camera module 249b may capture the subject in a direction opposite to the first display area A1. According to an embodiment, the first camera module 249a and/or the second camera module 249b may be disposed on the second housing 202.

According to an embodiment, an indicator (not shown) of the electronic device 101 may be disposed on the first housing 201 or the second housing 202, and the indicator may include a light emitting diode to provide state information about the electronic device 101 as a visual signal. The sensor module (not shown) of the electronic device 101 may produce an electrical signal or data value corresponding to the internal operation state or external environment state of the electronic device. The sensor module may include, for example, a proximity sensor, a fingerprint sensor, or a biometric sensor (e.g., an iris/face recognition sensor or a heartrate monitor (HRM) sensor). According to another embodiment, the sensor module may further include, e.g., at least one of a gesture sensor, a gyro sensor, an atmospheric pressure sensor, a magnetic sensor, an acceleration sensor, a grip sensor, a color sensor, an infrared (IR) sensor, a temperature sensor, a humidity sensor, or an illuminance sensor.

FIG. 1D is an exploded perspective view illustrating an electronic device according to an embodiment of the disclosure.

FIG. 1E is a cross-sectional view taken along line A-A′ of FIG. 1B according to an embodiment of the disclosure.

FIG. 1F is a cross-sectional view taken along line B-B′ of FIG. 1C according to an embodiment of the disclosure.

Referring to FIGS. 1D, 1E, and/or 1F, an electronic device 101 may include a first housing 201, a second housing 202, a display assembly 230, and a driving structure 240. The configuration of the first housing 201, the second housing 202, and the display assembly 230 of FIGS. 1D, 1E, and/or 1F may be identical in whole or part to the configuration of the first housing 201, the second housing 202, and the display 203 of FIGS. 1B and/or 1C.

According to an embodiment, the first housing 201 may include a first cover member 211 (e.g., the first cover member 211 of FIGS. 1B and 1C), a frame 213, and a first rear plate 215.

According to an embodiment, the first cover member 211 may receive at least a portion of the frame 213 and receive a component (e.g., battery 289) positioned in the frame 213. According to an embodiment, the first cover member 211 may be formed to surround at least a portion of the second housing 202. According to an embodiment, the second circuit board 249 receiving the electronic component (e.g., the processor 120 and/or the memory 130 of FIG. 1A) may be connected to the first cover member 211.

According to an embodiment, the frame 213 may be connected to the first cover member 211. For example, the frame 213 may be connected to the first cover member 211. The second housing 202 is movable relative to the first cover member 211 and/or the frame 213. According to an embodiment, the frame 213 may receive the battery 289. According to an embodiment, the frame 213 may include a curved surface 213a facing the display assembly 230.

According to an embodiment, the first rear plate 215 may substantially form at least a portion of the exterior of the first housing 201 or the electronic device 101. For example, the first rear plate 215 may be coupled to the outer surface of the first cover member 221. According to an embodiment, the first rear plate 215 may provide a decorative effect on the exterior of the electronic device 101. The first rear plate 215 may be formed of at least one of metal, glass, synthetic resin, or ceramic.

According to an embodiment, the second housing 202 may include a second cover member 221 (e.g., the second cover member 221 of FIGS. 1B and 1C), a rear cover 223, and a second rear plate 225.

According to an embodiment, the second cover member 221 may be connected to the first housing 201 through the guide rail 250 and, while being guided by the guide rail 250, reciprocate linearly in one direction (e.g., the direction of arrow \textcircled{1} in FIG. 1C).

According to an embodiment, the second cover member 221 may support at least a portion of the display 203. For example, the second cover member 221 may include a first surface F1. The first display area A1 of the display 203 may be substantially positioned on the first surface F1 to maintain a flat panel shape. According to an embodiment, the second cover member 221 may be formed of a metal material and/or a non-metal (e.g., polymer) material. According to an embodiment, the first circuit board 248 receiving the electronic component (e.g., the processor 120 and/or the memory 130 of FIG. 1A) may be connected to the second cover member 221.

According to an embodiment, the rear cover 223 may protect a component (e.g., the first circuit board 248) positioned on the second cover member 221. For example, the rear cover 223 may be connected to the second cover member 221 and may be formed to surround at least a portion of the first circuit board 248. According to an embodiment, the rear cover 223 may include an antenna pattern for communicating with an external electronic device. For example, the rear cover 223 may include a laser direct structuring (LDS) antenna.

According to an embodiment, the second rear plate 225 may substantially form at least a portion of the exterior of the second housing 202 or the electronic device 101. For example, the second rear plate 225 may be coupled to the outer surface of the second cover member 221. According to an embodiment, the second rear plate 225 may provide a decorative effect on the exterior of the electronic device 101. The second rear plate 225 may be formed of at least one of metal, glass, synthetic resin, or ceramic.

According to an embodiment, the display assembly 230 may include a display 231 (e.g., the display 203 of FIGS. 1B and/or 1C) and a multi-bar structure 232 supporting the display 203. According to an embodiment, the display 231 may be referred to as a flexible display, a foldable display, and/or a rollable display.

According to an embodiment, the multi-bar structure 232 may be connected to or attached to at least a portion (e.g., the second display area A2) of the display 231. According to an embodiment, as the second housing 202 slides, the multi-bar structure 232 may move with respect to the first housing 201. In the closed state of the electronic device 101 (e.g., FIG. 1B), the multi-bar structure 232 may be mostly received in the first housing 201 and may be positioned between the first cover member 211 and the second cover member 221. According to an embodiment, at least a portion of the multi-bar structure 232 may move corresponding to the curved surface 213a positioned at the edge of the frame 213. According to an embodiment, the multi-bar structure 232 may be referred to as a display supporting member or supporting structure and may be in the form of one elastic plate.

According to an embodiment, the driving structure 240 may move the second housing 202 relative to the first housing 201. For example, the driving structure 240 may include a motor 241 configured to generate a driving force for sliding the housings 201 and 202. The driving structure 240 may include a gear (e.g., a pinion) connected to the motor 241 and a rack 242 configured to mesh with the gear.

According to an embodiment, the housing in which the rack 242 is positioned and the housing in which the motor 241 is positioned may be different. According to an embodiment, the motor 241 may be connected to the second housing 202. The rack 242 may be connected to the first housing 201. According to another embodiment, the motor 241 may be connected to the first housing 201. The rack 242 may be connected to the second housing 202.

According to an embodiment, the first housing 201 may receive the first circuit board 248 (e.g., a main board). According to an embodiment, the processor, memory, and/or interface may be mounted on the first circuit board 248. The processor may include one or more of, e.g., a central processing unit, an application processor, a graphic processing device, an image signal processing, a sensor hub processor, or a communication processor. According to various embodiments, the first circuit board 248 may include a flexible printed circuit board type radio frequency cable (FRC). The first circuit board 248 may be disposed on at least a portion of the second cover member 221 and may be electrically connected to the antenna module and the communication module.

According to an embodiment, the memory may include, e.g., a volatile or non-volatile memory.

According to an embodiment, the interface may include, e.g., a high definition multimedia interface (HDMI), a universal serial bus (USB) interface, a secure digital (SD) card interface, and/or an audio interface. The interface may electrically or physically connect, e.g., the electronic device 101 with an external electronic device and may include a USB connector, an SD card/multimedia card (MMC) connector, or an audio connector.

According to an embodiment, the electronic device 101 may include a second circuit board 249 (e.g., a sub circuit board) spaced apart from the first circuit board 248 (e.g., a main circuit board) in the first housing 201. The second circuit board 249 may be electrically connected to the first circuit board 248 through a connection flexible board. The second circuit board 249 may be electrically connected with electric components disposed in an end area of the electronic device 101, such as the battery 289 or a speaker and/or a sim socket, and may transfer signals and power. According to an embodiment, the second circuit board 249 may receive a wireless charging antenna (e.g., coil). For example, the battery 289 may receive power from an external electronic device through the wireless charging antenna. As another example, the battery 289 may transfer power to the external electronic device by the wireless charging antenna.

According to an embodiment, the battery 289 may be a device for supplying power to at least one component of the electronic device 101. The battery 189 may include a primary cell which is not rechargeable, a secondary cell which is rechargeable, or a fuel cell. The battery 289 may be integrally or detachably disposed inside the electronic device 101. According to an embodiment, the battery 289 may be formed of a single embedded battery or may include a plurality of removable batteries. According to an embodiment, the battery 289 may be positioned in a frame 213, and the battery 289 may be slid along with the frame 213.

According to an embodiment, the guide rail 250 may guide the movement of the multi-bar structure 232. For example, the multi-bar structure 232 may slide along the slit 251 formed in the guide rail 250. According to an embodiment, the guide rail 250 may be connected to the first housing 201. For example, the guide rail 250 may be connected to the first cover member 211 and/or the frame 213. According to an embodiment, the slit 251 may be referred to as a groove or recess formed in the inner surface of the guide rail 250.

According to an embodiment, the guide rail 250 may provide pressure to the multi-bar structure 232 based on the driving of the motor 241.

According to an embodiment, when the electronic device 101 changes from the closed state to opened state, the inner portion 252 of the guide rail 250 may provide pressure to the multi-bar structure 232. The multi-bar structure 232 receiving the pressure may be moved along the slit 251 of the guide rail 250, and the second housing 202 may be changed from the slide-in state to slide-out state with respect to the first housing 201. At least a portion of the display assembly 230 accommodated between the first cover member 211 and the frame 213 may be extended to the front surface.

According to an embodiment, when the electronic device 101 changes from the opened state to closed state, an outer portion 253 of the guide rail 250 may provide pressure to the bent multi-bar structure 232. The multi-bar structure 232 receiving the pressure may be moved along the slit 251 of the guide rail 250, and the second housing 202 may be changed from the slide-out state to slide-in state with respect to the first housing 201. At least a portion of the display assembly 230 may be accommodated between the first cover member 211 and the frame 213.

Referring to FIG. 1E, in the closed state of the electronic device 101, at least a portion of the second housing 202 may be disposed to be received in the first housing 201. As the second housing 202 is disposed to be received in the first housing 201, the overall volume of the electronic device 101 may be reduced. According to an embodiment, when the second housing 202 is received in the first housing 201, the size of the visually exposed display 231 may be minimized. For example, if the second housing 202 is completely received in the first housing 201, the first display area A1 of the display 231 may be visually exposed, and the second display area A2 may not be visually exposed. At least a portion of the second display area A2 may be disposed between the battery 289 and the rear plates 215 and 225.

Referring to FIG. 1F, in the opened state of the electronic device 101, at least a portion of the second housing 202 may protrude from the first housing 201. As the second housing 202 is disposed to protrude from the first housing 201, the overall volume of the electronic device 101 may be increased. According to an embodiment, if the second housing 202 protrudes from the first housing 201, at least a portion of the second display area A2 of the display 231, together with the first display area A1, may be visually exposed to the outside of the electronic device 101.

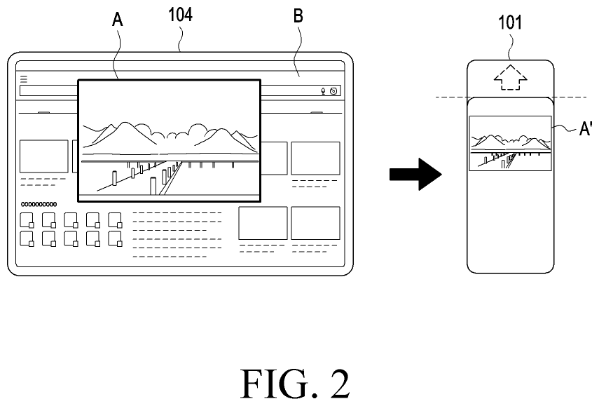

FIG. 2 is a view illustrating a connection relationship between an electronic device and an external electronic device according to an embodiment of the disclosure. Each of the electronic device 104 and the external electronic device 101 of FIG. 2 may include components identical or similar to those of the electronic device 101 of FIG. 1A. According to an embodiment, the external electronic device 101 may be the electronic device 101 described above with reference to FIGS. 1B to 1F.

Referring to FIG. 2, according to various embodiments, when the electronic device 104 is connected to the external electronic device 101, an operation for outputting data (e.g., content and screen data) of the electronic device 104 through the screen of the external electronic device 101 may be performed. In the following description, it is exemplified that the electronic device 104 establishes a communication channel using a communication module (e.g., the communication module 190 of FIG. 1A) to transmit and receive data to and from the external electronic device 101, but the electronic device 104 may also transmit and receive data through a wired connection.

The electronic device 104 for transmitting content may be referred to as a source device (or a host device), and the external electronic device 101 for receiving content may be referred to as a sink device (or a client device). Content output from the display of the electronic device 104 may be moved to and output from the display of the external electronic device 101 in real time, and the content movement may be performed according to various communication methods. According to an embodiment, the content movement may include at least one of transferring content from the source device to the sink device, sharing content between the source device and the sink device, or mirroring. Such content movement may be based on various communication schemes such as a Miracast communication scheme, a Dex communication scheme, or an AppCast communication scheme, and the communication scheme for content movement is not limited thereto.

For example, as illustrated in FIG. 2, a screen A of a first application may be displayed in a floating state on the entire screen (or background screen) B displayed on the electronic device 104. In response to a request to move the screen A of the first application, the screen A of the first application (or screen data related to application A) may be transferred to the external electronic device 101. Accordingly, the screen A′ of the first application may be displayed on the display of the external electronic device 101. Further, the screen of the second application along with the screen of the first application may be displayed on the display of the external electronic device 101 according to a user request while two or more applications (e.g., the first and second applications) are being executed in the electronic device 101. Further, FIG. 2 illustrates an example in which one external electronic device 101 is connected to the electronic device 104, but two or more external electronic devices may be connected to the electronic device 104, and different screens may be transferred to each connected external electronic device.

As described above, since various types of external electronic devices may be connected to the electronic device 104, when the electronic device 104 is connected to an external electronic device 101 having a resizable display, it is necessary to develop the display size manipulation function of the external electronic device 101 in a form capable of enhancing user convenience.

Hereinafter, an operation method based on whether the display of the external electronic device 101 is resizable when the electronic device 104 moves an object corresponding to at least one application in a state of being connected to the external electronic device 101 including a resizable flexible display is described in detail.

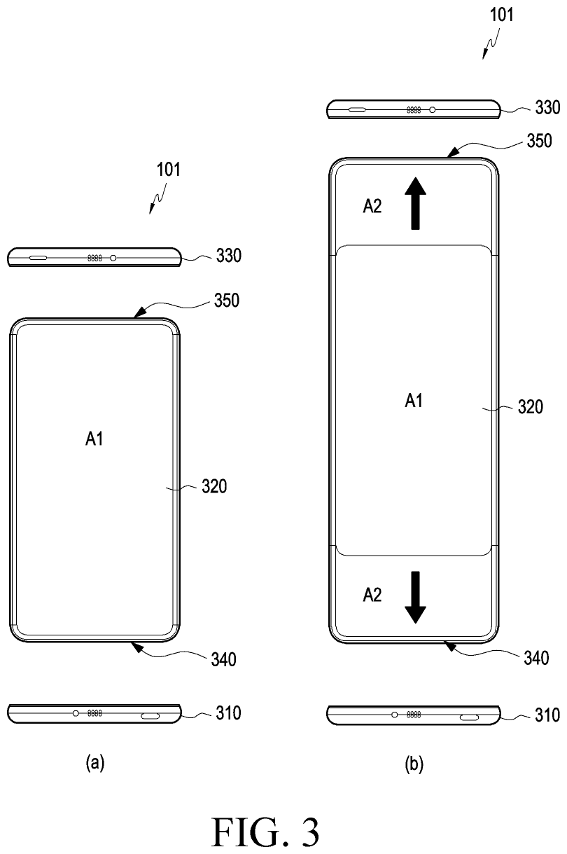

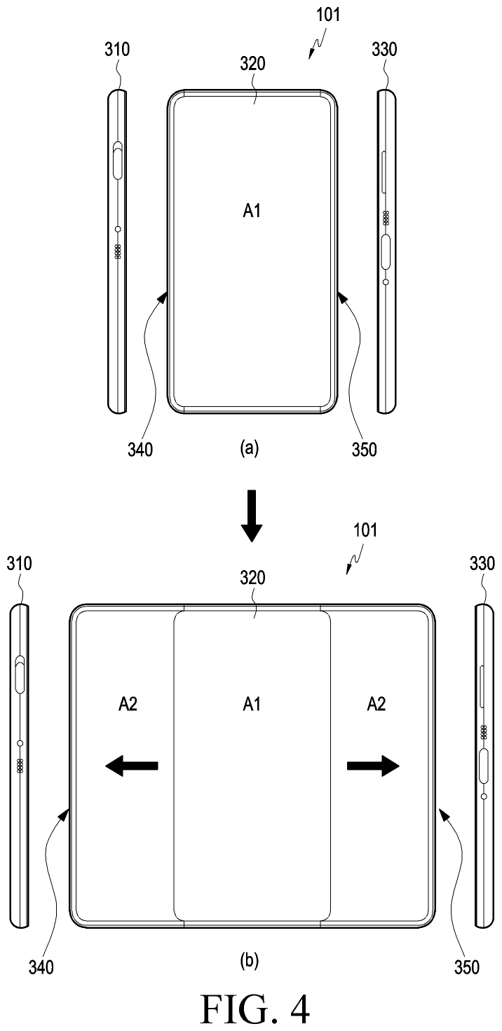

The above-described electronic device 101 in FIGS. 1B to 1F and the external electronic device 101 in FIGS. 3 and 4 have been mainly described as electronic devices including a flexible display, but are not limited thereto. For example, an electronic device having a resizable display may include a rolling type electronic device in which the display is rolled along a guide member such as a roller, and a sliding type electronic device in which the display is slidable.

Hereinafter, in the embodiments described below, an electronic device including a flexible display will be mainly described, and it should be noted that the following description may be applied to other types of electronic devices although not mentioned separately.

In the following description, the components easy to understand from the description of the above embodiments are denoted with or without the same reference numerals and their detailed description may be skipped. According to an embodiment of the disclosure, the electronic device 104 and the external electronic device 101 may be implemented by selectively combining configurations of different embodiments, and the configuration of one embodiment may be replaced by the configuration of another embodiment. However, it is noted that the disclosure is not limited to a specific drawing or embodiment.

FIG. 3 is an example view illustrating a shrunken and extended (or enlarged) state of a flexible display in a vertical (e.g., portrait mode) direction in an external electronic device according to an embodiment of the disclosure, and FIG. 4 is an example view illustrating a shrunken and extended state of a flexible display in a horizontal (e.g., landscape mode) direction in an external electronic device according to an embodiment of the disclosure. According to an embodiment, the external electronic device illustrated in FIG. 3 may be the electronic device 101 described above with reference to FIGS. 1B and 1C.

Part (a) of FIG. 3 and part (a) of FIG. 4 are views illustrating a state in which the flexible display is shrunken, and part (b) of FIG. 3 and part (b) of FIG. 4 are views illustrating an extended state in which most of the flexible display is exposed to the front surface of the external electronic device. According to an embodiment, the flexible display may be extended by a predetermined distance in one direction, and a structure capable of reciprocating for extension and shrinkage may be disposed.

Referring to part (a) of FIG. 3, part (b) of FIG. 3, part (a) of FIG. 4, and part (b) of FIG. 4, the external electronic device 101 may include a housing 320 and a display disposed in a space formed by the housing 320. At least a portion of the display may have a foldable or bendable, slidable, or rollable shape. The surface where the flexible display is disposed (or the surface where the display module is viewed from the outside of the external electronic device 101) may be defined as a front surface of the external electronic device 101. The opposite surface of the front surface may be defined as a rear surface of the external electronic device 101. Further, a surface surrounding a space between the front surface and the rear surface may be defined as a side surface of the external electronic device 101.

According to various embodiments, as illustrated in part (a) of FIG. 3 and part (b) of FIG. 3, a first sidewall 310 and a second sidewall 330 may be included in a second side surface (or a shorter side) (e.g., the side surface 340 or the side surface 350) of the housing 320. Further, as illustrated in part (a) of FIG. 4 and part (b) of FIG. 4, the housing 320 may include a first sidewall 310 and a second sidewall 330 on a first side surface (or a longer side) (e.g., the side surface 340 and the side surface 350). Further, according to various embodiments, a portion (e.g., the first area A1) of the display may be a basic use area when the display is in a shrunken (or slide-in) state, and another portion (e.g., the second area A2) of the display may be an extended area when the display is in an extended (or slide-out) state.

In the embodiment illustrated in part (a) of FIG. 3, the basic use area (e.g., the first area A1) in the shrunken state of the display is illustrated. According to the embodiment illustrated in part (b) of FIG. 3, the extended area (e.g., the second area A2) visually exposed when the display is extended may be formed in any one of the upper or lower portions of the display. According to various embodiments, as the side surface (e.g., the side surface 340 or the side surface 350) of the display linearly moves in the Y-axis direction, the size of the visually exposed display area of the display may be changed. For example, the display area of the flexible display may include a second area A2 extending from the first area A1 in any one direction (e.g., an upper or lower direction) when extended.

In an embodiment illustrated in part (a) of FIG. 4, the basic use area (e.g., the first area A1) in the shrunken state of the display is illustrated. According to an embodiment illustrated in part (b) of FIG. 4, the extended area (e.g., the second area A2) visually exposed when the display is extended may be formed on either the left side or the right side of the display. According to various embodiments, as the side surface (e.g., the side surface 340 or the side surface 350) of the display linearly moves in the X-axis direction, the size of the visually exposed display area of the display may be changed. For example, the display area of the flexible display may include a second area A2 extending from the first area A1 in any one direction (e.g., the left or right direction) when extended.

As illustrated in part (a) of FIG. 3, part (b) of FIG. 3, part (a) of FIG. 4, and part (b) of FIG. 4, the external electronic device 101 may switch from an open state to a closed state according to a display shrink event for reducing the area of the exposed flexible display. Conversely, according to a display enlarge event, the display may be switched from the closed state to the open state.

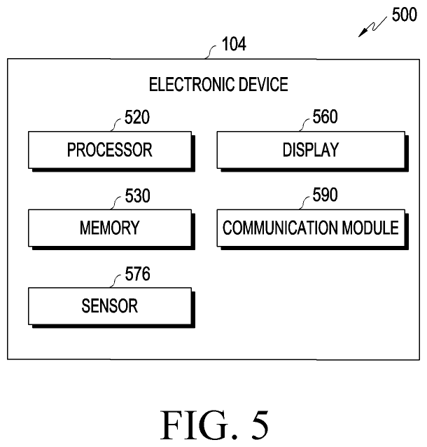

FIG. 5 is a block diagram 500 illustrating an internal configuration of an electronic device for controlling an external display device according to an embodiment of the disclosure.

Referring to FIG. 5, an electronic device 104 according to various embodiments may include a processor 520 (e.g., the processor 120 of FIG. 1A), memory 530 (e.g., the memory 130 of FIG. 1A), a display 560 (e.g., the display 160 of FIG. 1A), a sensor 576 (e.g., the sensor module 176 of FIG. 1A), and a communication module 590 (e.g., the communication module 190 of FIG. 1A). Here, not all of the components illustrated in FIG. 5 are essential components of the electronic device 104, and the electronic device 104 may be implemented with more or fewer components than those illustrated in FIG. 5.

The communication module 590 may be communicatively connected with an external electronic device 101. According to an embodiment, the communication module 590 may be connected to one or more external electronic devices through a 1:1 connection scheme or a 1:n connection scheme. According to an embodiment, the communication module 590 may be wirelessly connected to the external electronic device 101 through various communication schemes. Content such as an image and text output through the display 560 of the electronic device 104 may be output to the display of the external electronic device 101 in real time through the communication module 590. Further, the content output through the display 560 of the electronic device 104 may be moved to the external electronic device 101 according to user selection and output to the display of the external electronic device 101. The device for providing content as described above may be referred to as a source device, and the device for receiving content may be referred to as a sink device. In the following description, a case where the electronic device 104 is a source device and the external electronic device 101 is a sink device will be mainly described, but the disclosure is not limited thereto. According to an embodiment, in the following description, the source device is an electronic device such as a laptop computer or a tablet computer, and the sink device is an electronic device including a resizable flexible display.

According to various embodiments, the processor 520 may execute at least one application, and may visually output content corresponding to the application through the display 560. Here, the content may be referred to as an object corresponding to an application. The object may be an output result of at least one application currently being executed, and may include at least one of data objects generated while the application is executed, e.g., video data, audio data, or display information. Further, the object may be referred to as data related to the application being executed other than the content, screen data, and an application execution screen.

As described above, the object may indicate at least one of data displayed on a screen (e.g., the display 560 of the electronic device 104), e.g., text, an image, a graphic element related to the application being executed, a video file, a sound file, or a widget, and may mean an object movable to another screen (e.g., the display of the external electronic device 104).

According to an embodiment, the object may be superimposed on at least a portion of the display 560. For example, the processor 520 may display an object movable to the external electronic device 101 in the form of a window (e.g., a view) occupying a partial area of the entire screen (e.g., a background screen) output through the display 560. For example, a window output through the entire screen may correspond to a background screen, and a window output in a floating manner may correspond to a first application. As another example, the window output through the entire screen may correspond to the first application performed in the foreground environment of the electronic device 101, and the window output in the floating manner may correspond to the second application.

According to an embodiment, the object corresponding to the at least one application displayed on the display 560 may include data associated with the application being executed. According to another embodiment, the object corresponding to at least one application may be an object corresponding to an application that is not being executed in the electronic device 104. For example, the electronic device 104 may control the external electronic device 101 so that the external electronic device 101 executes an application that is not being executed by the electronic device 104 according to a drag input, and as the object is moved toward the external electronic device 101, an application execution screen corresponding to the object may be displayed on the flexible display of the external electronic device 101.

According to various embodiments, the processor 520 may identify a user input for displaying an application execution screen corresponding to the object on the flexible display of the external electronic device 101. For example, the processor 520 may share the screen corresponding to the object with the external electronic device 101 by receiving a drag input in which the object is selected by the user and drags toward the edge of the display 560. Here, the edge of the display 560 may correspond to the position where the external electronic device 101 is placed or the direction toward the external electronic device 101. In response to the drag input toward the edge of the display 560, the processor 520 may perform control so that a portion of the flexible display of the external electronic device 101 is pulled out from the inside of the external electronic device 101 and exposed to the outside of the external electronic device 101 using a control signal to the external electronic device 101, thereby extending (e.g., in an open state) the flexible display.

Conversely, the processor 520 may shrink (e.g., close) the flexible display by performing control so that a portion of the flexible display of the external electronic device 101 is inserted into the external electronic device 101 using the control signal to the external electronic device 101.

According to various embodiments, the processor 520 may search for a connectable device around the electronic device and then identify the connectable external electronic device 101 based on the search. According to an embodiment, the processor 520 may detect the external electronic device 101 in any one of the upper, lower, left, and right directions with respect to the front central axis of the electronic device 104 using the sensor 576 (e.g., the sensor 176 of FIG. 1). For example, the sensor 576 may include at least one of an infrared sensor, an ultrasonic sensor, a motion sensor, a 3D sensor, or a vision sensor, and the type of the sensor is not limited thereto. Information sensed by at least two of these sensors may be combined and used to identify the position and the placed state (e.g., a portrait state or a landscape state) of the external electronic device 101.

According to an embodiment, the processor 520 may identify not only the position and direction of the external electronic device 101, the distance from the external electronic device 101, and the placed state, but also the extended (or shrunken) state, based on the information obtained from the external electronic device 101 during the connection with the external electronic device 101. According to an embodiment, in response to the drag input toward the edge of the display 560 being detected, the processor 520 may identify the position and direction of the external electronic device 101, the distance from the external electronic device 101, the placed state, as well as the extended (or shrunken) state, based on the state information obtained from the external electronic device 101. Further, the detailed position of the connected external electronic device 101 may be adjusted through the setting menu.

According to various embodiments, the processor 520 may display an indicator for changing the size (or length) of the flexible display of the external electronic device 101 on at least a portion of the display 560 in response to a drag input in which the object is selected by the user and drags toward the edge of the display 560. The processor 520 may identify whether it is possible to change the size of the flexible display of the external electronic device 101 in response to the drag input. For example, in response to the drag input, the processor 520 may identify whether the flexible display of the external electronic device 101 may be extended or shrunken based on the state information obtained from the external electronic device 101.

Further, the processor 520 may identify whether the flexible display of the external electronic device 101 may be extended or shrunken based on the attribute of the object. Accordingly, when it is possible to extend or shrink the flexible display of the external electronic device 101, the processor 520 may control to display a screen corresponding to the resized object on the extended or shrunken flexible display by adjusting the size of the object.

According to an embodiment, the processor 520 may transmit a control signal for requesting extension of the flexible display to the external electronic device 101 through the communication module 590, may identify whether it is possible to change the size of the display based on information included in the response corresponding to the control signal, and may display an indicator for changing (or adjusting) the size (or length) of the flexible display of the external electronic device 101. According to an embodiment, the processor 520 may previously recognize whether it is possible to change the size of the flexible display of the external electronic device 101, based on the information obtained from the external electronic device 101 during the connection with the external electronic device 101. Accordingly, the processor 520 may directly display an indicator for changing the size of the flexible display of the external electronic device 101 in response to the drag input. For example, the processor 520 may display an indicator for shrinkage when the size of the flexible display is maximally extended, may display an indicator for extension when the size of the flexible display is maximally shrunken, and may display an indicator capable of both extension and shrinkage when the size of the flexible display is intermediate.

According to various embodiments, the processor 520 may perform control so that an application execution screen corresponding to the object is displayed on the resized flexible display of the external electronic device 101, based on an input for selecting the indicator. To that end, the processor 520 may transmit data related to the object to the external electronic device 101 through the communication module 590. For example, when the processor 520 transmits the data related to the object to the external electronic device 101, a screen corresponding to the object may be displayed on the extended or shrunken flexible display.

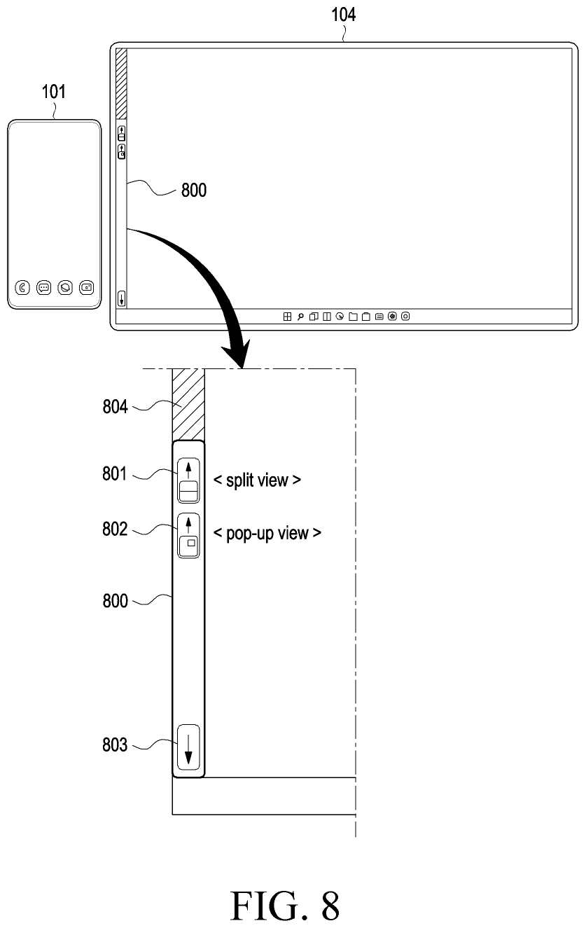

According to various embodiments, the processor 520 may determine whether to output an indicator capable of changing the size of the flexible display, not only according to an input for selecting the indicator, but also according to attributes (e.g., a size and a horizontal/vertical ratio) of an object to be moved and displayed. For example, when the object has a ratio of being displayable on the enlarged flexible display, the processor 520 may display an indicator indicating that the flexible display may be enlarged on at least a portion of the display 560. Further, the indicator may include an item indicating a split mode or a popup mode for displaying a screen corresponding to an object on the flexible display. The screen corresponding to the object may be displayed to occupy a partial area or the entire area of the flexible display. A method for displaying a screen corresponding to an object on a flexible display is described below with reference to FIG. 8.

According to various embodiments, the processor 520 may support a function of controlling a screen corresponding to an object displayed on the external electronic device 101. According to an embodiment, in response to the drag input, the processor 520 may display a pointer for controlling the screen on the screen corresponding to the object displayed on the external electronic device 101.

According to an embodiment, when the electronic device 104 is a laptop computer, a pointer (e.g., a cursor) for selecting the object may be displayed on the display 560, and the object indicated by the pointer may be moved toward the external electronic device 101 while being selected using a mouse. The processor 520 may also move and display a pointer indicating the object according to the movement of the object. Further, as the resizing of the flexible display is completed, the processor 520 may perform control so that a screen corresponding to the object is displayed on the flexible display, and as the object moves, the pointer may also be moved to and displayed on the external electronic device 101.

According to an embodiment, when the electronic device 104 is a tablet, an object on the display 560 may be selected through a touch input and may be touched and dragged. Further, similar to the touch input method for the object, a screen corresponding to the object on the external electronic device 101 may be controlled through a touch input. Accordingly, upon a drag input to an object on the display 560, the processor 520 may not display a pointer. For example, while the user moves the object onto the flexible display of the external electronic device 101 through a touch input to the object, the pointer indicating the object may not be displayed.

According to various embodiments, since the coordinates of the object on the display 560 and the coordinates of the screen corresponding to the object on the external electronic device 101 may be different from each other, the processor 520 may convert the coordinates using a scale value for resolution.

Accordingly, the processor 520 may provide a multi-control function based on the converted coordinates so as to perform a function corresponding to an input event on the display 560 or a position where the input event occurs on the screen corresponding to the object of the external electronic device 101. The processor 520 may output the updated screen in real time through the flexible display of the external electronic device 101 by transmitting data related to the screen (or the updated screen) changed according to the execution of the function corresponding to the position where the input event occurs to the external electronic device 101. Accordingly, by providing an indicator of being able to resize the flexible display of the external electronic device 101 in the electronic device 104 as well as the electronic device 104 with one mouse or keyboard through the multi-control function, the user may intuitively manipulate the change in the size of the flexible display of the external electronic device 101 when displaying the object movement.

The memory 530 may store instructions to enable the processor 520 to perform various operations when executed.

According to various embodiments, the memory 530 may be operatively connected to a display 560, a sensor 576, a communication module 590, and the processor 520 and may store instructions to perform a connection with an external electronic device 101, display a second screen (e.g., an application execution screen) different from a first screen on the first screen (e.g., a background screen) on the display 560, display an indicator for resizing a flexible display in response to a drag input for dragging to display the second screen on a flexible display of an external electronic device 101 and then transmit data related to the second screen to the external electronic device 101 based on an input selecting the indicator to thereby control to display the second screen on the resized flexible display.

According to various embodiments, an electronic device 104 may comprise a display 560, a communication module 590, and at least one processor 520. The at least one processor 520 may be configured to perform a connection with an external electronic device 101 including a flexible display extendable in one or more directions, display an object corresponding to at least one application execution screen on the display 560, identify a user input for displaying the object on a display of the external electronic device 101, display an indicator for resizing the flexible display on at least a portion of the display 560 based on the user input, and control to display the object on the resized flexible display based on an input selecting the indicator.

According to various embodiments, the at least one processor may be configured to transmit a control signal for requesting to extend the flexible display based on the input selecting the indicator, and transmit data related to the object to the external electronic device through the communication module based on the flexible display being extended.

According to various embodiments, the control signal may include information about a split mode or a popup mode for displaying an application execution screen corresponding to the object on the extended flexible display.

According to various embodiments, the at least one processor may be configured to control to display an indicator for extending the flexible display on at least a portion of the display corresponding to a direction toward the external electronic device.

According to various embodiments, the user input for displaying on the display of the external electronic device may include a drag movement for the object toward an edge of the display corresponding to a direction toward the external electronic device.

According to various embodiments, the input selecting the indicator may include the user input to move the object onto or adjacent to the indicator.

According to various embodiments, the at least one processor may be configured to control to display an application execution screen corresponding to the object on the flexible display not extended, based on the user input to move out of the indicator.

According to various embodiments, the at least one processor may be configured to identify an extending direction of the flexible display based on the user input, and display the indicator including an item indicating the extending direction on at least a portion of the display in response to identifying the extending direction of the flexible display.

According to various embodiments, the at least one processor may be configured to identify an attribute of the object, resize the object to correspond to a size of the extended flexible display based on the attribute of the object, and then control to display an application execution screen corresponding to the resized object on the extended flexible display.

According to various embodiments, the at least one processor may be configured to identify at least one of a position, a direction, or a placed state of the external electronic device while performing the connection with the external electronic device.

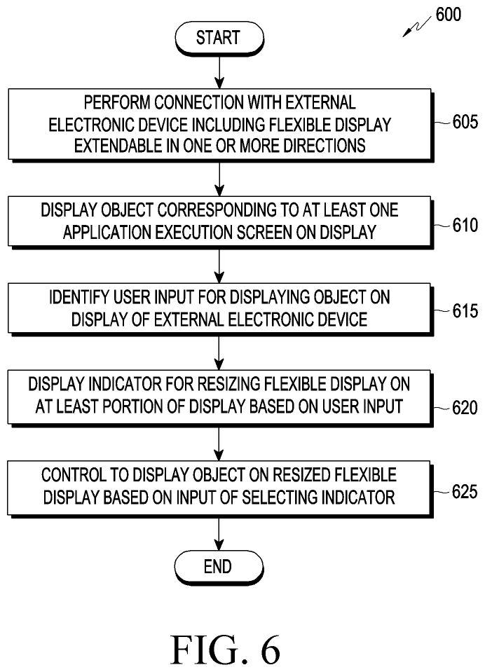

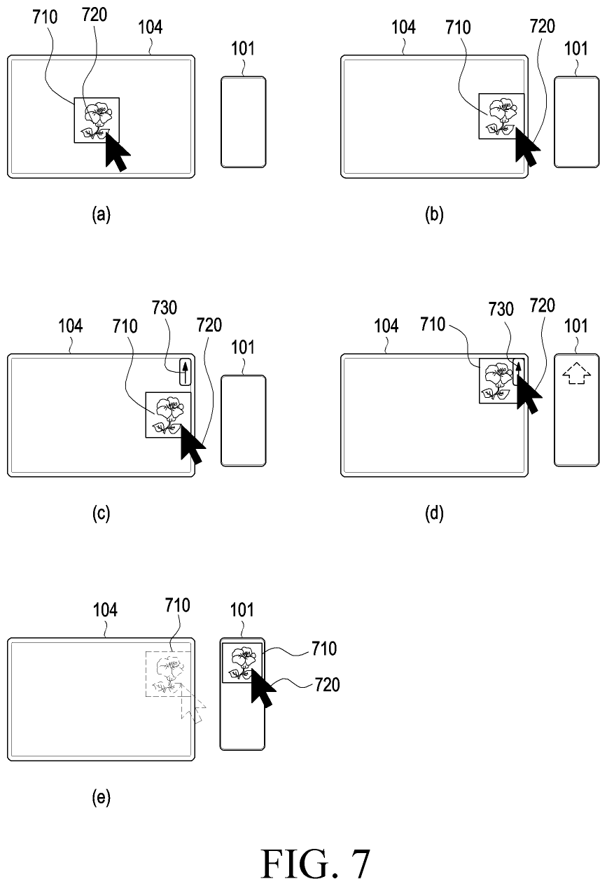

FIG. 6 is a flowchart 600 illustrating operations of an electronic device to control an external electronic device according to an embodiment of the disclosure. FIG. 6 may be described with reference to FIG. 7 for a better understanding. FIG. 7 is a view illustrating an example of sharing content related to at least one application output on a display of an electronic device with an external electronic device according to an embodiment of the disclosure.

Referring to FIG. 6, the operation method may include operations 605 to 625. Each operation of the operation method of FIG. 6 may be performed by an electronic device (e.g., the electronic device 101 of FIG. 1A, the electronic device 104 of FIG. 2, or the electronic device 104 of FIG. 5) or at least one processor (e.g., at least one of the processor 120 of FIG. 1A or the processor 520 of FIG. 5) of the electronic device.

In operation 605, the electronic device 104 may perform connection with the external electronic device 101 including a flexible display extendable in one or more directions. Further, the external electronic device 101 may start connecting with the electronic device 104. According to an embodiment, the electronic device 104 may identify at least one of the position of the external electronic device 101 or the distance, the direction, or the placed state from the external electronic device 104 while performing connection with the external electronic device 101.

In operation 610, the electronic device 104 may display an object corresponding to at least one application execution screen on the display 560 of the electronic device 104. According to an embodiment, the object corresponding to the at least one application may include data associated with the application being executed.

In operation 615, the electronic device 104 may identify a user input for displaying the object on the flexible display of the external electronic device 101. For example, the object represents an application execution screen and may be a target movable to the external electronic device 101.

According to an embodiment, the user input for displaying on the display of the external electronic device 101 may include a drag movement for the object toward the edge of the display corresponding to the direction toward the external electronic device 101. For example, the user may select the object through, e.g., a touch input or a click using a mouse in the state in which the object is indicated using an indicator (e.g., a cursor) indicating the object corresponding to at least one application on the display 560, and may move the object toward the external electronic device 101 based on a drag input for dragging after selecting the object. In the case of the touch input method, the indicator indicating the object may be omitted.

In operation 620, the electronic device 104 may display an indicator for resizing the flexible display on at least a portion of the display 560, based on the user input. According to an embodiment, the indicator may include an item (e.g., an arrow) indicating the extending or shrinking direction of the flexible display, and the item may be displayed on or around a portion of the indicator. The electronic device 104 may obtain state information (e.g., an extended state, a shrunken state, or an intermediate state) from the external electronic device 101 in the step of performing connection or in the step of detecting the movement of the object. For example, when the size of the flexible display of the external electronic device 101 is maximally extended, the electronic device 104 may display an indicator including an item indicating the shrinking direction; when the size of the flexible display of the external electronic device 101 is maximally shrunken, the electronic device 104 may display an indicator including an item indicating the extending direction; and when the size of the flexible display of the external electronic device 101 is intermediate, the electronic device 104 may display an indicator including an item of being capable of both the extending and shrinking directions.

According to an embodiment, the operation of displaying the indicator for extension of the flexible display may include the operation of identifying the extending direction of the flexible display, based on the user input and the operation of displaying the indicator including the item indicating the extending direction on at least a portion of the display, in response to the identification of the extending direction of the flexible display.

For example, when the flexible display of the external electronic device 101 disposed at a position adjacent to the center of the electronic device 104 is extendable in the upper direction, the indicator may include an arrow indicating the upper direction. Further, when the flexible display is extendable in the right direction, the indicator may include an arrow indicating the right direction. Accordingly, in the case of a flexible display extendable in one or more directions, in response to a user input for moving and displaying an object displayed on the display 560 to the flexible display, the electronic device 104 may display an indicator including an arrow indicating any one of the extendable or shrinkable directions of the flexible display, e.g., the upper, lower, left, and right directions. Accordingly, by displaying an indicator indicating a direction in which the display is resizable, the user may intuitively know in which direction the flexible display of the external electronic device 101 is resizable.

In operation 625, the electronic device 104 may perform control so that the object is displayed on the resized flexible display, based on an input for selecting the indicator. For example, the electronic device 104 may perform control so that an application execution screen corresponding to the object is displayed on the extended flexible display. According to an embodiment, the input for selecting the indicator may include a user input for moving (or dragging) the object onto or adjacent to the indicator. According to another embodiment, the electronic device 104 may perform control to move the object and display the corresponding screen without resizing the flexible display, based on the user input for moving the object out of the indicator. For example, when a user input for moving an object is received through an area other than the area in which the indicator is displayed, the electronic device 104 may regard it as an input to be moved and displayed without changing the display size of the flexible display.

According to an embodiment, the electronic device 104 may transmit a control signal for requesting extension of the flexible display to the external electronic device 101, based on an input for selecting the indicator. Based on the extension of the flexible display, the electronic device 104 may transmit data related to the object to the external electronic device 101 so that an application execution screen corresponding to the object is displayed.

According to an embodiment, the control signal may include information about a split mode or a popup mode for displaying the application execution screen corresponding to the object on the extended flexible display.

According to an embodiment, the operation of controlling to display the screen corresponding to the object on the extended flexible display may include the operation of controlling to display an indicator for extension of the flexible display on at least a portion of the display corresponding to a direction toward the external electronic device 101.

According to an embodiment, the operation of controlling to display the screen corresponding to the object on the extended flexible display may include the operation of identifying an attribute of the object, the operation of adjusting the size of the object to correspond to the size of the extended flexible display, based on the attribute of the object, and the operation of controlling to display an application execution screen corresponding to the object of the adjusted size on the extended flexible display.

Referring to part (a) of FIG. 7, an object 710 corresponding to an application may be output on the display 560 of the electronic device 104 in the form of a partial screen and may be output in the form of a floating window. In the state in which the object 710 is displayed, the user may select the object 710 using the pointer 720 (e.g., a cursor) and then start a drag input dragging to the external electronic device 101 positioned adjacent to the electronic device 104 for mirroring (or moving). As illustrated in part (a) of FIG. 7, when a user input (e.g., drag input) to the object 710 is detected, an application associated with the object to be displayed on the external electronic device 101 (or capable of moving and displaying the object) may be determined.

Referring to part (b) of FIG. 7, the electronic device 104 may determine whether there is an external electronic device 101 connected in a direction in which an object moves (or drags), and may identify whether the selected object 710 moves in the direction toward the external electronic device 101. For example, in response to reaching a position (or an adjacent area) adjacent to the edge of the display 560 when the selected object 710 moves, the electronic device 104 may output an indicator 730 including an item for indicating that the flexible display is resizable when the electronic device 104 is connected to the external electronic device 101 as illustrated in part (c) of FIG. 7. For example, the electronic device 104 may provide an item such as an arrow indicating that an extendable area may be provided in the flexible display when mirroring, within the indicator 730 or at a position adjacent thereto. According to an embodiment, when the electronic device 104 is connected to the external electronic device 101, the electronic device 104 may identify at least one of the position or the placed state of the external electronic device 101, based on information provided from the external electronic device 101, and may identify the position or the placed state of the external electronic device 101 set by the user through the configuration menu. Accordingly, as illustrated in part (c) of FIG. 7, the electronic device 104 may display an indicator 730 that serves to lead to extension in a direction in which the flexible display is resizable in an edge area of the display 560 corresponding to the position or direction of the external electronic device 101.

Part (c) of FIG. 7 illustrates an example in which an indicator for indicating that the flexible display is extendable in an upper direction is displayed, but in the case of a flexible display having two or more extendable directions, e.g., it may be indicated that the flexible display is extendable in at least one of an upper direction, a lower direction, a left direction, and a right direction, and the extending direction of part (c) of FIG. 7 may not be limited thereto.

According to an embodiment, when an execution screen of at least one application is output through the display 560, a specific application does not support a display in a vertical direction (portrait orientation), and thus data of the execution screen of the application may be provided with respect to the horizontal direction. In this case, since the display direction of the flexible display needs to be based on the direction supported by the application, the extending direction of the flexible display may be changed corresponding to the executed application. According to another embodiment, the size and/or display direction of the object may be changed before the movement to the flexible display is completed corresponding to the extending direction of the flexible display and/or the state in which the flexible display is placed (e.g., the horizontal state or the vertical state).

Referring to part (d) of FIG. 7, the electronic device 104 may perform control so that at least a portion of the flexible display is exposed in response to selection of the indicator 730 indicating the extendable direction. According to an embodiment, the electronic device 104 may transmit a control signal for requesting extension of the flexible display to the external electronic device 101, based on an input for selecting the indicator 730. For example, when the drag input for moving the object 710 by the user is on the indicator 730 or adjacent to the indicator 730, the resizing of the flexible display may start. Here, the drag input may be regarded as an input for the user to change the size of the flexible display when a designated time elapses, e.g., N seconds, in the state in which the drag input is positioned on the indicator 730.

Referring to part (e) FIG. 7, the electronic device 104 may move the object 710 based on whether at least a portion of the object 710 is out of the edge area or whether the object 710 stays in the edge area for a predetermined time or longer. Accordingly, the screen corresponding to the object 710 may be displayed on the resized flexible display. The electronic device 104 may perform control so that the flexible display of the external electronic device 101 is resized when at least a portion of the object 710 is out of the edge area or the object 710 stays in the edge area for a predetermined time or longer without displaying an indicator, i.e., when movement of the object 710 is detected. As illustrated in part (e) of FIG. 7, the pointer 720 indicating the object 710 may also be moved and displayed on the resized flexible display. To that end, the drag input selecting the object 710 may be transferred to the external electronic device 101.

According to an embodiment, the electronic device 104 may display a screen corresponding to the object 710 on the flexible display based on completion of the resizing of the flexible display. However, when the user moves the pointer 720 before the resizing of the flexible display is completed, the electronic device 104 may display the screen corresponding to the object 710 on the flexible display in the state in which the resizing of the flexible display is stopped. Considering the time when the size of the flexible display is changed as described above, the object 710 may be moved in the state in which the extension is completed or before the extension is completed according to the user selection.

FIG. 8 is an example view illustrating a method for selecting a display mode when a flexible display of an external electronic device is extended according to an embodiment of the disclosure. In FIG. 8, mirroring may be described as an example of object movement.

Referring to FIG. 8, when an object is moved (e.g., mirrored) in a state in which the external electronic device 101 is placed on the left side of the electronic device 104, an indicator 800 for extending the flexible display of the external electronic device 101 may be displayed on a portion of the display of the electronic device 104, e.g., a portion corresponding to a state in which the external electronic device 101 is placed (e.g., a horizontal state or a vertical state) and a direction toward the external electronic device 101.

According to various embodiments, when mirroring, the electronic device 104 may control (or manipulate) the size (e.g., enlarge or reduce) of the flexible display of the external electronic device 101, and may also control the screen display scheme on the flexible display.

Meanwhile, in the above description, the case of changing (or adjusting) the size of the flexible display in the vertical direction (e.g., the upper direction or the lower direction) has been described as an example, but embodiments of the disclosure may be equally applied to the external electronic device 101 that changes (or adjusts) the size of the flexible display in the horizontal direction (e.g., the right direction or the left direction).

As illustrated in FIG. 8, the electronic device 104 may perform control to a screen corresponding to an object in a split view mode or a popup view mode on a resized, e.g., extended flexible display. According to an embodiment, the indicator 800 may include at least one of a split view mode 801, a popup view mode 802, and a function indicating shrinkage 803 of the flexible display, as well as a function for changing the size of the flexible display.

The split view mode 801 may be a mode in which screens are displayed to be separated in different areas on the flexible display of the external electronic device 101. For example, an application screen currently running in the external electronic device 101 and a screen corresponding to an object moved from the electronic device 104 may be displayed to be separated from each other in different areas of the flexible display. Further, when an object corresponding to each of two or more applications is moved in the electronic device 104, the screens corresponding to each object may be displayed separately in each area in a designated order or in a movement order.

The popup view mode 802 may be a mode in which a screen corresponding to an object is displayed to overlap an application screen being executed on a flexible display of the external electronic device 101.

The function indicating the shrinkage 803 of the flexible display may support a function for shrinking and displaying the flexible display when the user displays the object movement when the flexible display of the external electronic device 101 connected to the electronic device 104 is in the enlarged state.

According to an embodiment, when the user does not want to resize the flexible display during mirroring, the electronic device 104 may support a function of not resizing the flexible display. For example, in response to the user input moving an object selected by the user through an area 804 outside the indicator 800, the electronic device 104 may perform control so that a screen corresponding to the object is displayed on the flexible display, the size of which is not changed.

According to an embodiment, FIG. 8 illustrates an item indicating the split view mode 801 and the popup view mode 802, but simultaneously with resizing the flexible display, a screen corresponding to an object may be displayed on the flexible display in various screen display schemes other than those described above. For example, a screen corresponding to an object may be displayed on the flexible display in a freestyle mode, and as an example, they may be displayed to overlap each other based on the priority of the application. If the object selected by the user moves between the item indicating the popup view mode 802 and the item indicating the shrinkage 803, the application execution screen corresponding to the object may be displayed on the flexible display without resizing the flexible display of the external electronic device 101.

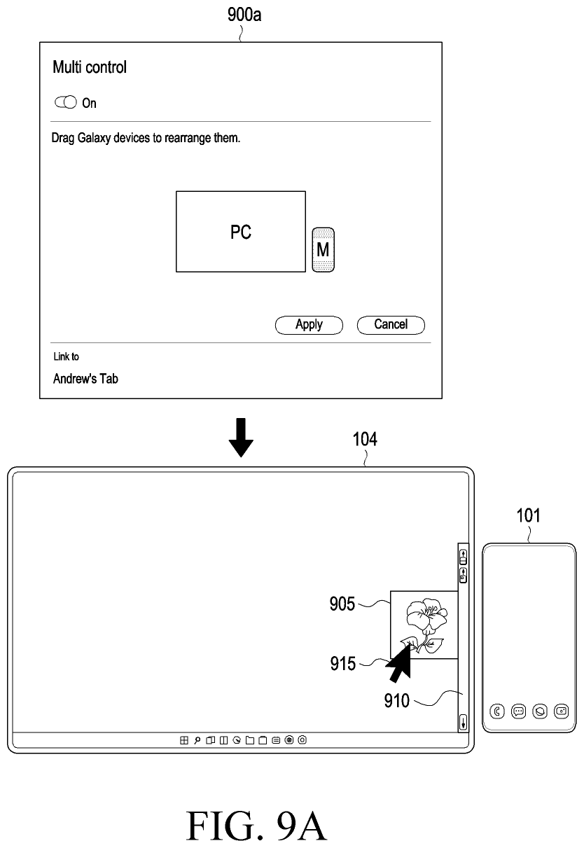

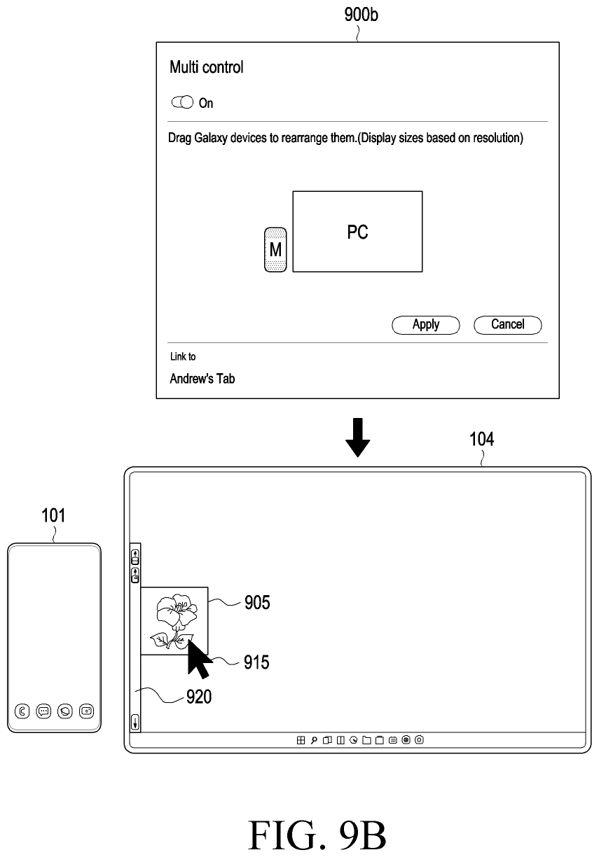

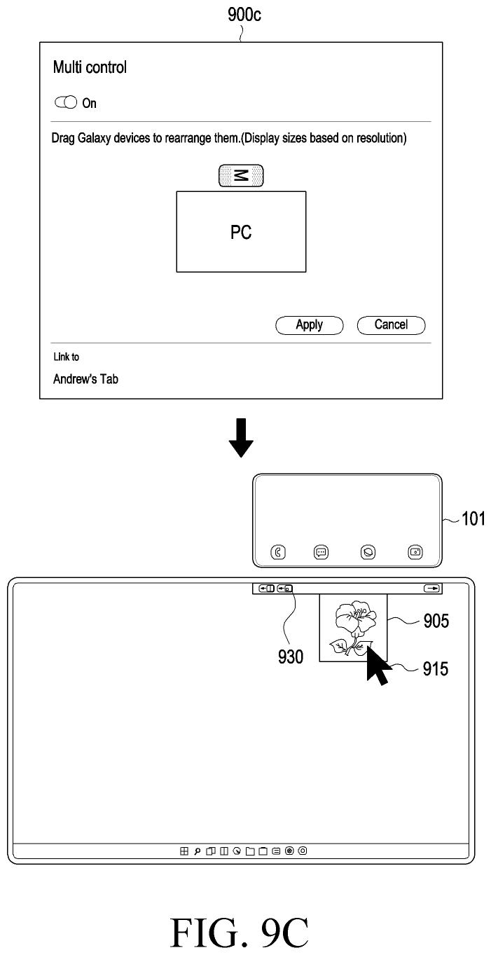

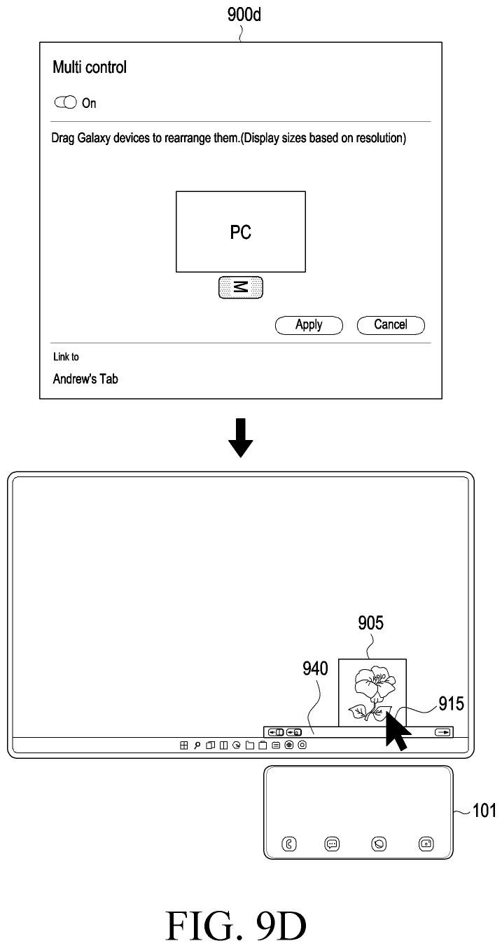

FIGS. 9A to 9D are example views illustrating a method for setting a position where an external electronic device is placed with respect to an electronic device according to various embodiments of the disclosure.

FIG. 9A illustrates a setting menu 900a for setting a case where the external electronic device 101 is placed on the right side with respect to the front central axis of the electronic device 104. By using the setting menu 900a, the user may determine which side to put and use the external electronic device 101 before or during connection with the external electronic device 101 in order to manipulate the electronic device 104 and the external electronic device 101 with one pointer through the multi-control function.

Referring to FIG. 9A, when the external electronic device 101 is set to be mirrored when the external electronic device 101 is placed on the right side through the setting menu 900a, an indicator 910 related to the resizing of the flexible display may be displayed on the right edge area when moving to the edge of the display of the electronic device 104 through a drag input moving after selecting the object 905 indicated by the pointer 915 displayed on the electronic device 104. When the drag input is detected at a left edge, the indicator may not be displayed, and the indicator may be configured to appear when moving to an edge corresponding to a set right direction.

Referring to FIG. 9B, when the external electronic device 101 is set to be placed on the left side with respect to the electronic device 104 through the setting menu 900b, an indicator 920 related to the resizing of the flexible display may be displayed on the left edge area of the display of the electronic device 104 based on detecting a drag input on the left edge. Here, the length of the indicator 920 may correspond to the length of the external electronic device 101.

Referring to FIG. 9C, when the external electronic device 101 is set to be placed on the upper side with respect to the electronic device 104 through the setting menu 900c, an indicator 930 related to the resizing of the flexible display may be displayed on the upper edge area of the display of the electronic device 104 based on detecting a drag input on the upper edge. As illustrated in FIG. 9C, not only the position where the external electronic device 101 is placed but also the placed state (e.g., the horizontal state or the vertical state) may be set through the setting menu 900c.

Referring to FIG. 9D when the external electronic device 101 is set to be placed on the lower side with respect to the electronic device 104 through the setting menu 900d, an indicator 940 related to the resizing of the flexible display may be displayed on the lower edge area of the display of the electronic device 104 based on detecting a drag input on the lower edge.

Meanwhile, FIGS. 9A to 9D illustrate an example of previously setting at least one of the position and placed state of the external electronic device 101 through the setting menu. However, the position where the external electronic device 101 is placed or the placed direction (e.g., horizontal state or vertical state) when connecting to the external electronic device 101 may be identified using the sensor 576 of the electronic device 101, or the position and placement direction in which the external electronic device 101 is placed may be identified based on information provided from the external electronic device 101 during connection with the external electronic device 101. Methods for identifying the position and placement direction in which the external electronic device 101 is placed may not be limited thereto.

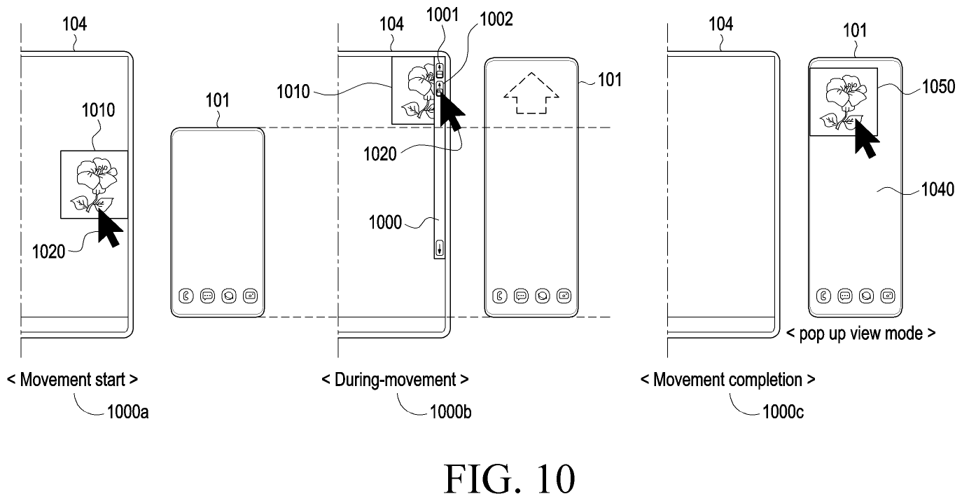

FIG. 10 is an example view illustrating a screen on an extended flexible display corresponding to selection of a split view mode when an object moves in an electronic device according to an embodiment of the disclosure.

Referring to FIG. 10, in the case of movement start 1000a, in state in which an object 1010 corresponding to an application is displayed in a floating manner on at least a portion of the display of the electronic device 104, the user may start a drag input selecting the object 1010 using a pointer 1020 (e.g., a cursor or a touch input) and then dragging it to an external electronic device 101 at a position adjacent to the electronic device 104 for mirroring.

While moving 1000b, the electronic device 104 may identify whether the selected object 1010 is moved toward the external electronic device 101. When the object 1010 moves to the edge area of the display toward the external electronic device 101 by the drag input, the electronic device 104 may identify whether the flexible display of the external electronic device 101 is extendable, based on the drag input detected in the edge area, and then may display the indicator 1000 for extending the flexible display of the external electronic device 101 on at least a portion of the display.

For example, when the object 1010 dragged by the pointer 1020 moves on the indicator 1000, the electronic device 104 may transmit a control signal for extending the flexible display of the external electronic device 101 to the external electronic device 101. The flexible display of the external electronic device 101 may be extended in a designated direction in response to the control signal. Here, the electronic device 104 may provide not only an extension function, but also a display method function capable of designating a screen display method on the extended flexible display. According to an embodiment, the indicator 1000 may include not only a function for resizing the flexible display, but also a function for indicating shrinkage of the split view 1001, the popup view 1002, or the flexible display.

In the case of the movement completion 1000c, e.g., when the drag input for moving the object 1010 by the user is positioned on the popup view 1002 of the indicator 1000 for a predetermined time, the electronic device 104 may regard it as a user input for selecting the popup view 1002 function. Accordingly, the flexible display of the external electronic device 101 may start to enlarge, and the electronic device 104 may move the object 1010 based on completion of the enlargement of the flexible display. Accordingly, the screen 1050 corresponding to the object 1010 may be superimposed on the previous screen 1040 of the flexible display in the form of a popup.

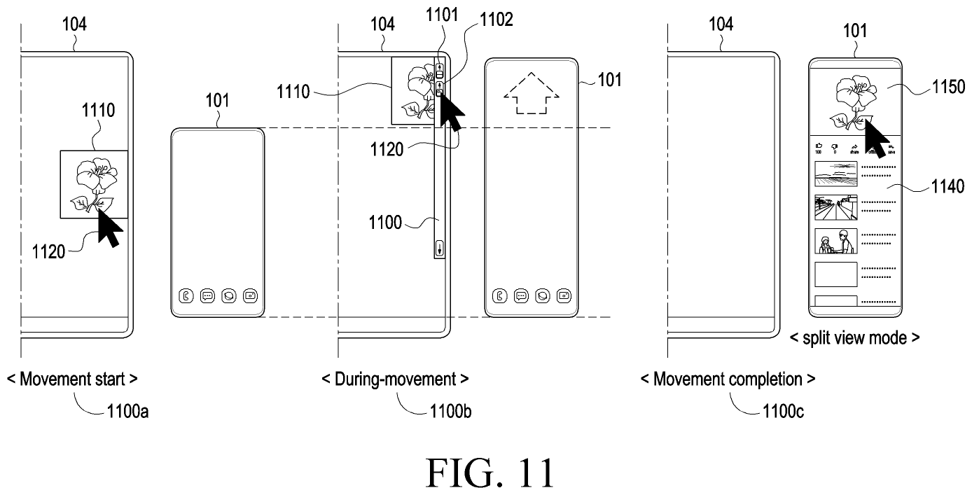

FIG. 11 is an example view illustrating a screen on an extended flexible display corresponding to selection of a popup view mode when an object moves in an electronic device according to an embodiment of the disclosure.

Referring to FIG. 11, in the case of movement start 1100a and during-movement 1100b, when the object 1110 selected by the pointer 1120 moves to the edge area of the display toward the external electronic device 101 by a drag input, the electronic device 104 may display an indicator 1100 including a split view 1101 function and a popup view function 1102 for extending the flexible display on at least a portion of the display corresponding to the direction toward the external electronic device 101.

In the case of movement completion 1100c, e.g., when a drag input for moving the object 1110 by the user is positioned on the split view 1101 of the indicator 1100 for a predetermined time, the electronic device 104 may regard it as a user input for selecting the split view 1101 function. Accordingly, the flexible display of the external electronic device 101 may start to be enlarged, and the electronic device 104 may move the object 1110 based on completion of enlargement of the flexible display. If the previous screen 1140 is already displayed on the flexible display, the previous screen 1140 and the application execution screen 1150 corresponding to the object 1110 may be disposed and displayed in the split areas, respectively, of the flexible display.

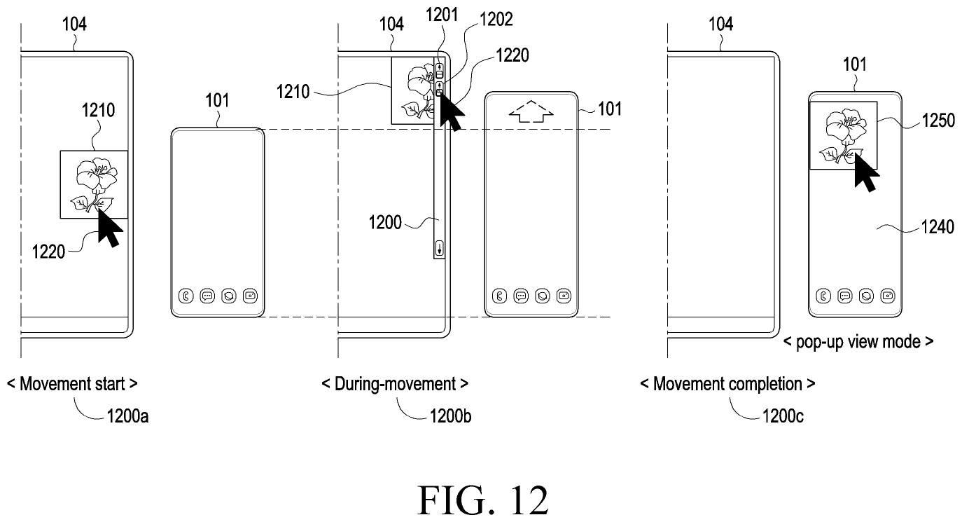

FIG. 12 is an example view illustrating a screen on a flexible display before extension is completed, corresponding to selection of a popup view mode when an object moves in an electronic device according to an embodiment of the disclosure.

FIG. 12 illustrates an example in which the popup view function 1202 included in the indicator 1200 is selected by pointer 1220, but as compared to FIG. 11, the operations of the movement start 1200a and during-movement 1200b are the same, but it differs in that the object 1210 is moved and displayed before the extension of the flexible display is completed. For example, the electronic device 104 may transmit a control signal to enlarge the flexible display of the external electronic device 101 in response to selection of the popup view 1202 mode of the split view 1201 mode and the popup view 1202 mode included in the indicator 1200. If the object 1210 is moved by a drag input before the enlargement of the flexible display is completed, e.g., before the maximum size is reached, the electronic device 104 may perform control so that the enlargement of the flexible display is stopped. For example, when the user wants to enlarge and use the flexible display to the maximum size, the user may wait until the enlargement is completed, but when the user determines that the size of the flexible display has reached the desired size, the user may stop the enlargement by dragging and moving the object 1210 positioned on the item indicating the popup view 1202 function before the enlargement is completed. Accordingly, in the case of movement completion 1200c, a screen (1250) corresponding to the object 1210 may be displayed in a popup form on the flexible display (1240) enlarged to a desired size.

Meanwhile, FIGS. 10 to 12 illustrate a case in which an indicator for resizing a flexible display includes not only a function for resizing the flexible display, but also a function for instructing to shrink a split view, a popup view, or the flexible display, but they may be selectively included as necessary. For example, assuming that the size (or ratio) of the object dragged by the user input is increased to the maximum size by adjusting (resizing) with respect to the horizontal width of the electronic device 104, if the adjusted size of the object exceeds the maximum size of the split view supportable by the external electronic device 101, even if it is displayed on the flexible display of the external electronic device 101, a portion of the screen corresponding to the object may be cut off and displayed. Accordingly, the split view function may not be included in the indicator so that the electronic device 104 does not support the split view function. In other words, the option for the split view function may not be displayed.

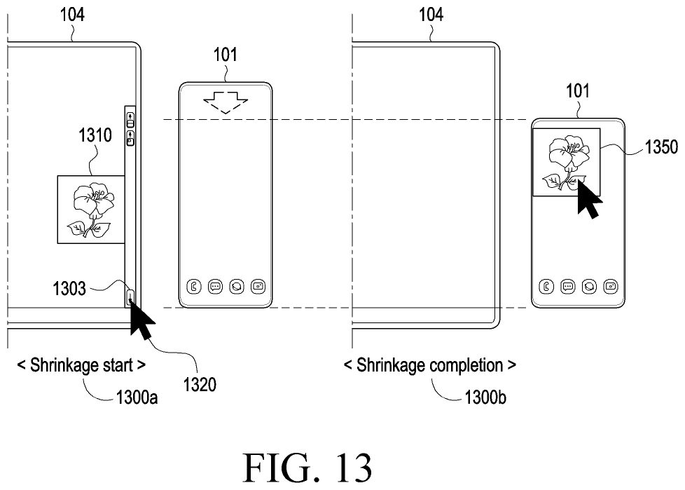

FIG. 13 is an example view illustrating a screen on a shrunken flexible display corresponding to selection of a shrink function when an object moves in an electronic device according to an embodiment of the disclosure.

Referring to FIG. 13, in the case of shrinkage start 1300a, when the object 1310 moves to the edge area of the display toward the external electronic device 101 by the user input, the electronic device 104 may identify whether the flexible display of the external electronic device 101 is shrinkable, based on the drag input detected in the edge area, and then may display the indicator including a function 1303 for shrinking the flexible display of the external electronic device 101 on at least a portion of the display. When the pointer 1320 is positioned on the function 1303 for shrinkage for a predetermined time by the drag input, the shrinkage of the flexible display of the external electronic device 101 may start. Accordingly, when the shrinkage is completed 1300b, an application execution screen 1350 corresponding to the moved object 1310 may be displayed on the shrunken flexible display.

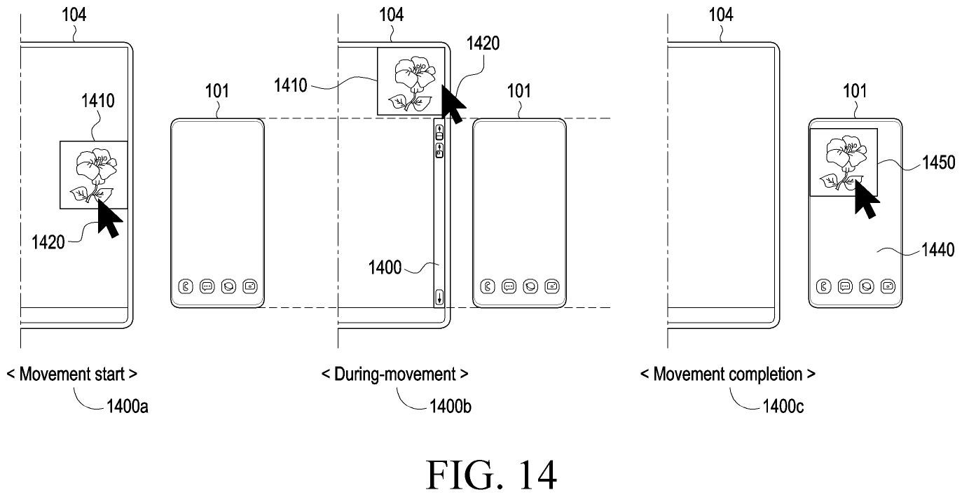

FIG. 14 is an example view illustrating a screen where a screen corresponding to an object is displayed without resizing of a flexible display when an object moves according to an embodiment of the disclosure.

Referring to FIG. 14, in the case of movement start 1400a, when the object 1410 selected by the pointer 1420 moves to the edge area of the display toward the external electronic device 101 by a drag input, the electronic device 104 may display an indicator 1400 for extending the flexible display on at least a portion of the display corresponding to the direction toward the external electronic device 101.

According to an embodiment, when the user does not want to resize the flexible display during mirroring, it may support a function of not resizing the flexible display. Accordingly, the electronic device 104 may move the object 1410 by a user input without resizing the flexible display and display the screen corresponding to the object 1410 on the flexible display. For example, in the case of during-movement 1400b, in response to the user input for moving the object 1410 selected by the user through an area outside the indicator 1400 (or the edge area where the indicator 1400 is not displayed), the electronic device 104 may perform control so that the application execution screen 1450 corresponding to the object is superimposed on the existing screen 1440 on the flexible display, the size of which has not been changed, when the movement is completed 1400c, as illustrated.

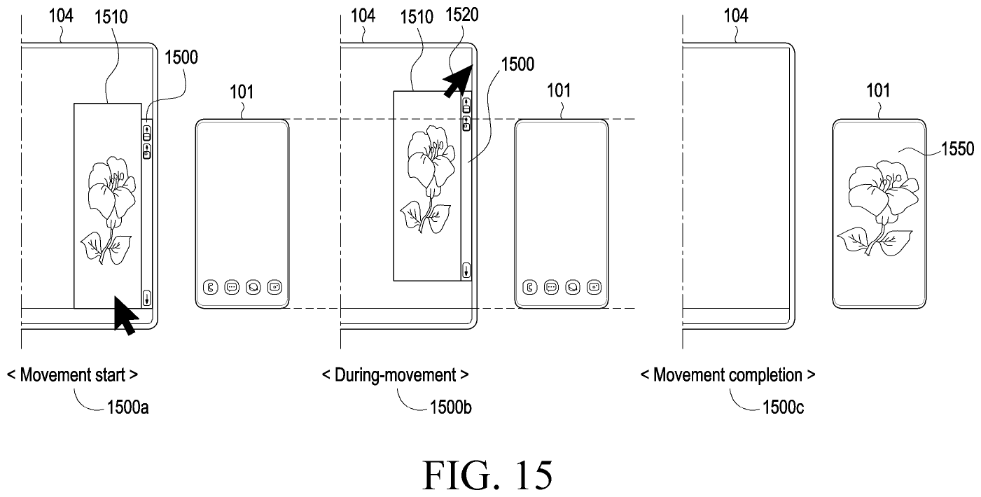

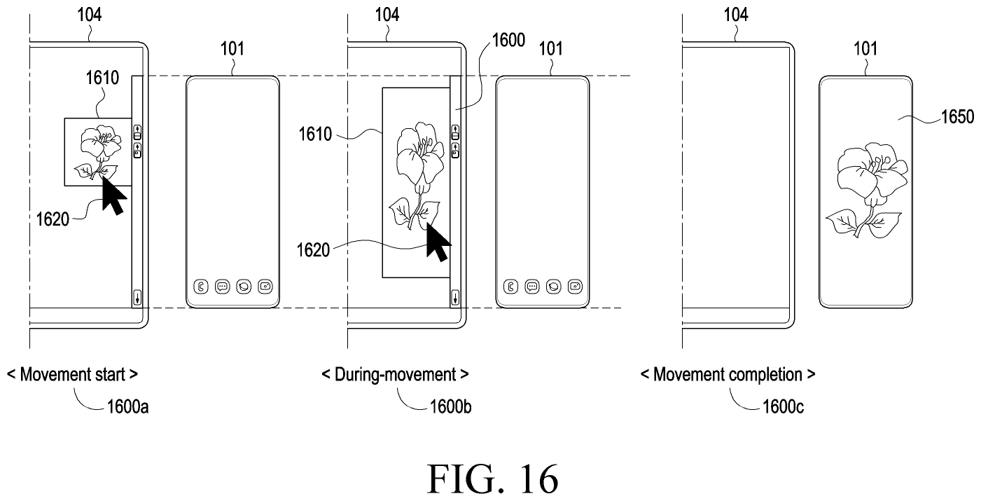

FIG. 15 is an example view illustrating a screen in which a flexible display is automatically enlarged to correspond to the size of an object according to an embodiment of the disclosure. FIG. 16 is an example view illustrating a screen in which a flexible display is automatically shrunken to correspond to the size of an object according to an embodiment of the disclosure.

Referring to FIGS. 15 and 16, as illustrated in the case of movement start 1500a and 1600a and during-movement 1500b and 1600b, the electronic device 104 may display an indicator 1500 and 1600 for extending the flexible display as the object 1510 and 1610 selected by the pointer 1520 and 1620 moves toward the edge area of the display 160 of electronic device 101 by the drag input.

Referring to FIG. 15, the electronic device 104 may transmit a control signal for requesting to extend the size of the flexible display according to the size of the selected object 1510 to the external electronic device 101. Accordingly, as illustrated upon movement completion 1500c, the application execution screen 1550 corresponding to the selected object 1510 may be displayed on the flexible display extended to correspond to the size of the selected object 1510. For example, this may correspond to a case where the vertical size with respect to the horizontal size of the object related to the application is larger than the size (or length) of the flexible display and, when the flexible display is extended, it is displayable according to the size of the object.

Referring to FIG. 16, the electronic device 104 may transmit a control signal for requesting to reduce the size of the flexible display according to the size of the selected object 1610 to the external electronic device 101. Accordingly, as illustrated upon movement completion 1600c, the screen 1650 corresponding to the selected object 1610 may be displayed on the flexible display shrunken to correspond to the size of the selected object 1610. For example, it may correspond to a case where the vertical size with respect to the horizontal size of the object related to the application is smaller than the size of the enlarged flexible display and, when the flexible display is shrunken, it is displayable according to the size of the object.

Meanwhile, in the above description, the case of extending or shrinking the flexible display to correspond to the size of the object has been described as an example, but after adjusting the size of the object to correspond to the size of the extended flexible display or the size of the shrunken flexible display, the object having the adjusted size may be moved and displayed.

For example, the electronic device 104 may control to adjust the size of the object selected during mirroring and then display the screen corresponding to the adjusted object on the enlarged or shrunken flexible display.

According to an embodiment, the electronic device 104 may control to display the screen corresponding to the adjusted object on the flexible display having the size corresponding to the resized object upon movement completion by moving through the area where the indicator is not displayed so that the flexible display is not resized after the object is resized according to the size of the flexible display. As described above, the electronic device 104 may move and display the object with the object resized to correspond to the size of the enlarged flexible display or, after controlling to enlarge the flexible display to correspond to the size of the object, move and display the object. For example, the application corresponding to the resizable object may include at least one of a video application, an image application, or a game application.

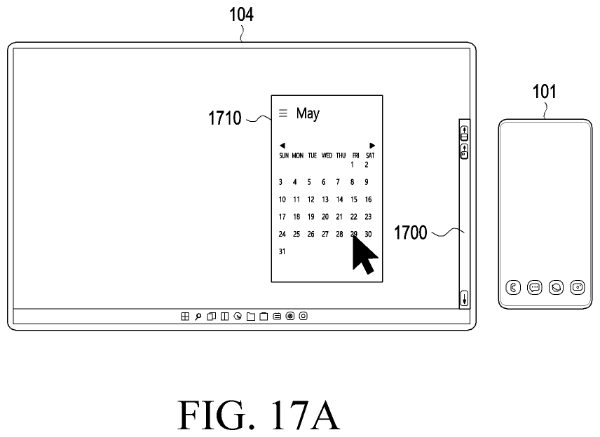

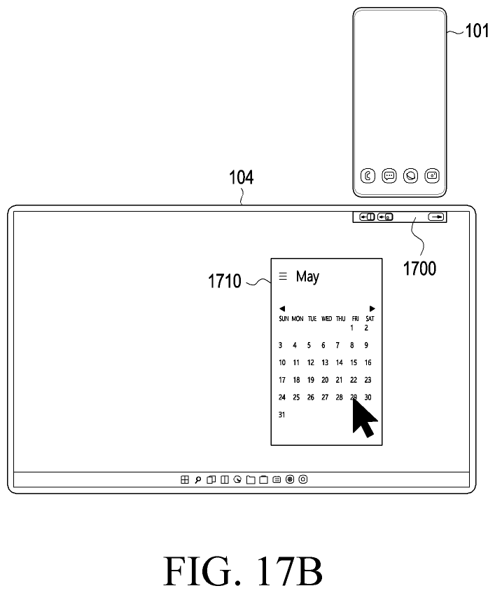

FIGS. 17A and 17B are example views illustrating a screen based on attributes of an object and an external electronic device in a vertical state according to various embodiments of the disclosure.

FIG. 17A illustrates an example in which an indicator 1700 for resizing a flexible display is displayed based on an attribute of an object 1710 displayed on a display of an electronic device 104, a position of an external electronic device 101, and a placed state. Referring to FIG. 17A, the electronic device 104 may identify the attribute of the object 1710 and may adjust the size of the object 1710 to correspond to the size of the extended flexible display based on the attribute of the object 1710. Accordingly, the electronic device 104 may perform control so that a screen corresponding to the resized object is displayed on the extended flexible display. For example, as illustrated in FIG. 17A, when the attribute of the object 1710 is an attribute of a vertical type and the connected external electronic device 101 is disposed on the right side of the electronic device 104 in the vertical state, the electronic device 104 may output a vertical indicator 1700 corresponding to the vertical state of the external electronic device 101 and the vertical attribute of the object 1710.

On the other hand, as illustrated in FIG. 17B, when the attribute of the object 1710 is an attribute of a vertical type and the connected external electronic device 101 is disposed above the electronic device 104 in the vertical state, the electronic device 104 may output a short indicator 1700 corresponding to the horizontal side of the external electronic device 101.

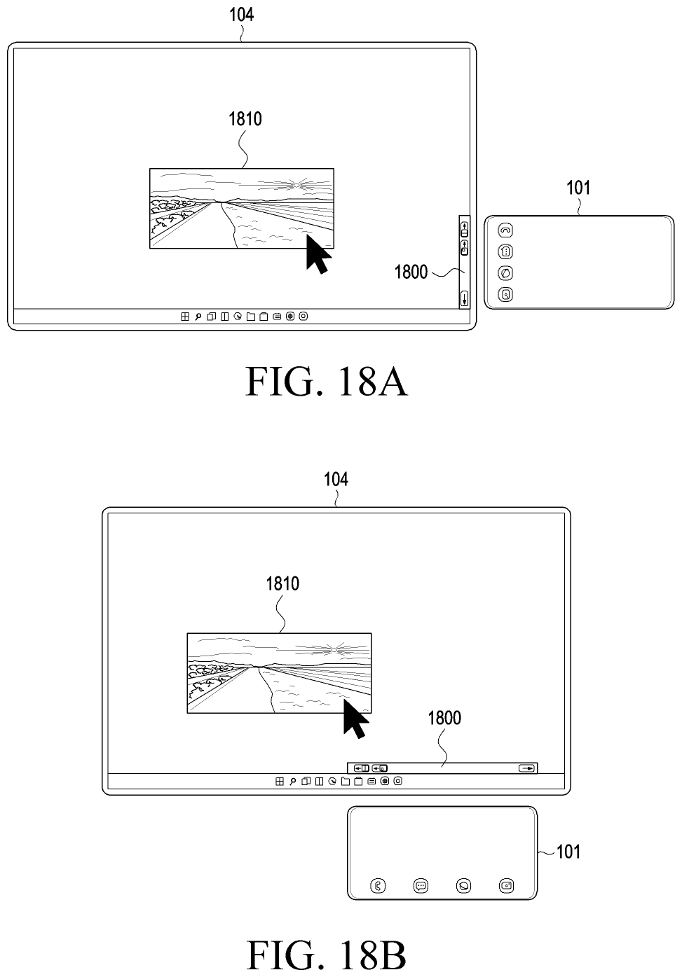

FIGS. 18A and 18B are example views illustrating a screen based on attributes of an object and an external electronic device in a horizontal state according to various embodiments of the disclosure. Referring to FIG. 18A, when the attribute of the object 1810 is an attribute of a horizontal type and the connected external electronic device 101 is disposed on the right side of the electronic device 104 in the horizontal state, the electronic device 104 may output a short indicator 1800 corresponding to the shorter side of the external electronic device 101 and the horizontal object 1810.

On the other hand, referring to FIG. 18B, when the attribute of the object 1810 is an attribute of a horizontal type and the connected external electronic device 101 is disposed under the electronic device 104 in the horizontal state, the electronic device 104 may output a wide indicator 1800 corresponding to the longer side of the external electronic device 101 and the horizontal object 1810.

In the above description, in relation to the size (or length) of the flexible display of the external electronic device 101 and the manipulation of the screen display scheme, as an example of executable functions, the extension, shrinkage, split view mode, and popup view mode have been described as examples, but the functions that may be provided in relation to the manipulation by the electronic device 104 may not be limited thereto.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, in a non-volatile storage medium storing instructions configured to, when executed by at least one processor of an electronic device, enable the electronic device to perform at least one operation, the at least one operation may comprise performing a connection with the external electronic device including a flexible display extendable in one or more directions, displaying an object corresponding to at least one application execution screen on a display of the electronic device, identifying a user input for displaying the object on a flexible display of the external electronic device, displaying an indicator for resizing the flexible display on at least a portion of the display based on the user input, and controlling to display a screen corresponding to the object on the resized flexible display based on an input selecting the indicator.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a display;
a communication module;
memory storing one or more computer programs; and
one or more processors communicatively coupled to the communication module, the display, and the memory,
wherein the one or more computer programs include computer-executable instructions that, when executed by the one or more processors individually or collectively, cause the electronic device to:
perform a connection with an external electronic device including a flexible display extendable in one or more directions,
display an object corresponding to at least one application execution screen on the display,
identify a user input for displaying the object on the flexible display of the external electronic device,
display an indicator for resizing the flexible display on at least a portion of the display based on the user input, and
control to display the object on the resized flexible display based on an input selecting the indicator.

2. The electronic device of claim 1, wherein the one or more computer programs further include computer-executable instructions that, when executed by the one or more processors individually or collectively, cause the electronic device to:
transmit a control signal for requesting to extend the flexible display based on the input selecting the indicator, and
transmit data related to the object to the external electronic device through the communication module based on the flexible display being extended.

3. The electronic device of claim 2, wherein the control signal includes information about a split mode or a popup mode for displaying an application execution screen corresponding to the object on the extended flexible display.

4. The electronic device of claim 1, wherein the one or more computer programs further include computer-executable instructions that, when executed by the one or more processors individually or collectively, cause the electronic device to control to display an indicator for extending the flexible display on at least a portion of the display corresponding to a direction toward the external electronic device.

5. The electronic device of claim 1, wherein the user input for displaying on the display of the external electronic device includes a drag movement for the object toward an edge of the display corresponding to a direction toward the external electronic device.

6. The electronic device of claim 1, wherein the input selecting the indicator includes the user input to move the object onto or adjacent to the indicator.

7. The electronic device of claim 6, wherein the one or more computer programs further include computer-executable instructions that, when executed by the one or more processors individually or collectively, cause the electronic device to control to display an application execution screen corresponding to the object on the flexible display not extended, based on the user input to move out of the indicator.

8. The electronic device of claim 1, wherein the one or more computer programs further include computer-executable instructions that, when executed by the one or more processors individually or collectively, cause the electronic device to:
identify an extending direction of the flexible display based on the user input, and
display the indicator including an item indicating the extending direction on at least a portion of the display in response to identifying the extending direction of the flexible display.

9. The electronic device of claim 1, wherein the one or more computer programs further include computer-executable instructions that, when executed by the one or more processors individually or collectively, cause the electronic device to:
identify an attribute of the object;
resize the object to correspond to a size of the extended flexible display based on the attribute of the object; and
control to display an application execution screen corresponding to the resized object on the extended flexible display.

10. The electronic device of claim 1, wherein the one or more computer programs further include computer-executable instructions that, when executed by the one or more processors individually or collectively, cause the electronic device to identify at least one of a position, a direction, or a placed state of the external electronic device while performing the connection with the external electronic device.

11. A method performed by an electronic device to share a screen with an external electronic device, the method comprising:
performing a connection with the external electronic device including a flexible display extendable in one or more directions;
displaying an object corresponding to at least one application execution screen on a display of the electronic device;
identifying a user input for displaying the object on the flexible display of the external electronic device;
displaying an indicator for resizing the flexible display on at least a portion of the display based on the user input; and
controlling to display a screen corresponding to the object on the resized flexible display based on an input selecting the indicator.

12. The method of claim 11, further comprising:
transmitting a control signal for requesting to extend the flexible display based on the input selecting the indicator; and
transmitting data related to the object to the external electronic device based on the flexible display being extended,
wherein the control signal includes information about a split mode or a popup mode for displaying an application execution screen corresponding to the object on the extended flexible display.

13. The method of claim 11, wherein controlling to display the application execution screen corresponding to the object on the extended flexible display includes controlling to display an indicator for extending the flexible display on at least a portion of the display corresponding to a direction toward the external electronic device.

14. The method of claim 11, wherein the user input for displaying on the display of the external electronic device includes a drag movement for the object toward an edge of the display corresponding to a direction toward the external electronic device.

15. The method of claim 11, wherein the input selecting the indicator includes the user input to move the object onto or adjacent to the indicator.

16. The method of claim 15, further comprising:
displaying an application execution screen corresponding to the object on the flexible display not extended, based on the user input to move out of the indicator.

17. The method of claim 11, further comprising:
identifying an extending direction of the flexible display based on the user input, and
displaying the indicator including an item indicating the extending direction on at least a portion of the display in response to identifying the extending direction of the flexible display.

18. The method of claim 11, further comprising:
identifying an attribute of the object;
resizing the object to correspond to a size of the extended flexible display based on the attribute of the object; and
controlling to display an application execution screen corresponding to the resized object on the extended flexible display.

19. One or more non-transitory computer-readable storage media storing one or more computer programs including computer-executable instructions configured to, when executed by one or more processors of an electronic device, individually or collectively, cause the electronic device to perform at least one operation, the at least one operation comprising:
performing a connection with an external electronic device including a flexible display extendable in one or more directions;
displaying an object corresponding to at least one application execution screen on a display of the electronic device;
identifying a user input for displaying the object on the flexible display of the external electronic device;
displaying an indicator for resizing the flexible display on at least a portion of the display based on the user input; and
controlling to display a screen corresponding to the object on the resized flexible display based on an input selecting the indicator.

20. The one or more non-transitory computer-readable storage media of claim 19, the at least one operation further comprising:
transmitting a control signal for requesting to extend the flexible display based on the input selecting the indicator; and
transmitting data related to the object to the external electronic device through a transceiver based on the flexible display being extended.
